(19) United States
(12) Patent Application Publication
(10) Pub. No.: US 2021/0384574 A1
(43) Pub. Date: Dec. 9, 2021

(54) Adhesive Composition and Thermally Fusible Member Using the Same

(71) Applicant: TOAGOSEI CO., LTD., Minato-ku, Tokyo (JP)

(72) Inventors: Takahiro ITO, Nagoya-shi, Aichi (JP); Makoto HIRAKAWA, Nagoya-shi, Aichi (JP); Hideki HIRAOKA, Nagoya-shi, Aichi (JP)

(21) Appl. No.: 17/288,345

(22) PCT Filed: Oct. 29, 2019
(86) PCT No.: PCT/JP2019/042381

§ 371 Date: Apr. 23, 2021

(30) Foreign Application Priority Data
Oct. 29, 2018 (JP) 2018-203112

(51) Int. Cl. H01M 50/129; C08F 255/02; C09J 151/06; C09J 11/06; H01M 10/0525

(52) U.S. Cl. CPC H01M 50/129; C08F 255/02; C08F 2810/20; C09J 11/06; H01M 10/0525; C09J 151/06

(57) ABSTRACT

An adhesive composition including: an organic solvent; (A) a polyolefin that has an acid anhydride group and that is soluble in the organic solvent; and a cross-linking agent, in which a ring-opening ratio of an anhydrous ring of the acid anhydride group in (A) the polyolefin is from 0 to 60%, and a thermally fusible member using the same.

### TECHNICAL FIELD

The present invention relates to an adhesive composition and a thermally fusible member using the same, can be used in various industrial products in the electrical, automotive and other industrial fields, and belongs to these technical fields.

### BACKGROUND ART

A hot-melt type adhesive composition is processed into a film or a sheet for use, and is used, as an adhesive film or sheet in which the adhesive composition is layered on the surface of a member, in various industrial products in the electrical, automotive and other industrial fields.

Various adhesive compositions have been proposed in order to bond metal members used in these fields made of, for example, iron, aluminum, titanium, other metals and their alloys to molded bodies made of polyolefin, which are poor in adhesiveness.

Patent Document 1 discloses an adhesive composition in which a component consisting of a carboxylic acid-containing polyolefin, a carboxylic acid-containing epoxy resin, a polyisocyanate compound, and, as necessary, an epoxy resin, is dissolved and dispersed in an organic solvent.

Patent Document 2 discloses an adhesive composition that contains a polyolefin having a carboxyl group or an acid anhydride group, a polyfunctional isocyanate compound, and a solvent, in which the glass transition temperature, the melting point, and the fusion energy of the polyolefin are specific values.

Further, since an acid-modified polymer that is obtained by grafting an organic acid having an unsaturated double bond to a polymer having low polarity has an acid-modified portion with high polarity and a polymer main chain with low polarity, it is used as a surface preparation agent for coating polyolefin resins such as polypropylene, which conventionally has been considered to be a poorly adhesive resin, or as an adhesive raw material for bonding polyolefins to each other or for bonding polyolefins to polar materials such as metals.

A general battery packaging material used for a laminated battery has a three-layer structure with an aluminum foil intermediate, and an adhesive is used between each layer. The three layers are a base material layer that constitutes the outside of the battery after forming the laminated battery, a barrier layer that is formed from aluminum or stainless steel foil, which prevents penetration of moisture, air, and the like, and a sealant layer for the purposes of insulating so that the barrier layer does not come into contact with electrodes or electrolyte and thermally fusion bonding and affixing the outer periphery, and the formation of each of these layers using two or more layers is also practiced. Among these, an olefin-based film such as a polypropylene film is used for the sealant layer that contacts the electrolyte, and an acid-modified polyolefin or an acid-modified styrene-based elastomer in which a cross-linking agent is formulated as necessary, a polyurethane in which polyhydroxy polyolefin is cross-linked with an isocyanate-based cross-linking agent, or the like, is used for adhesion with the aluminum foil.

Among these, an adhesive composed of an acid-modified polyolefin and an isocyanate-based cross-linking agent has been widely used in recent years because high adhesive strength can be obtained.

An adhesive composed of an acid-modified polyolefin and a cross-linking agent is mainly used as an adhesive solution with the adhesive dissolved in a solvent, and a laminated film is produced by a method known as a dry laminating method in which the adhesive solution is applied to an aluminum foil or a film for a sealant layer and dried, after which the aluminum foil and a polyolefin film are affixed.

Further, the laminated film is favorably used, for example, for a laminated secondary battery.

Examples of a packaging material for a battery case using an adhesive composed of an acid-modified polyolefin and an isocyanate-based cross-linking agent include those described in Patent Documents 3 and 4.

Patent Document 3 describes a packaging material for a battery case, which includes a heat-resistant resin stretched film layer as an outer layer, a thermoplastic resin unstretched film layer as an inner layer, and an aluminum foil layer disposed between these two film layers, in which the thermoplastic resin unstretched film layer and the aluminum foil layer are bonded to each other via an adhesive layer that contains a polyolefin resin having a carboxyl group and a polyfunctional isocyanate compound.

Patent Document 4 describes a packaging material for a battery case, which includes a heat-resistant resin stretched film layer as an outer layer, a thermoplastic resin unstretched film layer as an inner layer, and an aluminum foil layer disposed between these two film layers, in which the thermoplastic resin unstretched film layer and the aluminum foil layer are bonded to each other via an adhesive layer that contains a polyolefin resin having a carboxyl group and a polyfunctional isocyanate compound, and the equivalent ratio [NCO]/[OH] of isocyanate groups of the polyfunctional isocyanate compound with respect to hydroxyl groups constituting carboxyl groups of the polyolefin resin is from 1.0 to 10.0.

### PRIOR ART DOCUMENTS

### Patent Documents

Patent Document 1: Japanese Patent Application Laid-Open No. H4-18480

Patent Document 2: Japanese Patent Application Laid-Open No. 2015-36385

Patent Document 3: Japanese Patent Application Laid-Open No. 2010-92703

Patent Document 4: Japanese Patent Application Laid-Open No. 2014-89985

### SUMMARY OF INVENTION

### Technical Problem

A problem to be solved by the present invention is to provide an adhesive composition having a long working life even when it is cured using a cross-linking agent, and a thermally fusible member using the same.

### Solution to Problem

As a result of intensive research to solve the problem described above, the present inventors have found that an adhesive composition containing an organic solvent, a polyolefin that has an acid anhydride group and that is soluble in the organic solvent, and a polyfunctional isocyanate compound, in which the anhydrous ring of the acid anhydride group contained in the polyolefin is opened at a specific ratio, has a sufficient working life even after adding a curing agent, and the adhesive composition can be favorably used for a packaging material for lithium ion batteries, and the present inventors have completed the present invention based on these findings.

Means for solving the above-described problem include the following aspects.

<1> An adhesive composition, comprising: an organic solvent; (A) a polyolefin that has an acid anhydride group and that is soluble in the organic solvent; and a cross-linking agent, wherein a ring-opening ratio of an anhydrous ring of the acid anhydride group in (A) the polyolefin is from 0 to 60%.

<2> The adhesive composition according to <1>, wherein the ring-opening ratio of the anhydrous ring of the acid anhydride group in (A) the polyolefin is from 5 to 60%.

<3> The adhesive composition according to <1>, wherein the ring-opening ratio of the anhydrous ring of the acid anhydride group in (A) the polyolefin is from 0 to 20%.

<4> The adhesive composition according to any one of <1> to <3>, wherein the cross-linking agent is an isocyanate compound.

<5> The adhesive composition according to <4>, wherein the isocyanate compound is (B) an isocyanate compound having an alicyclic structure and/or a derivative thereof.

<6> The adhesive composition according to <5>, wherein the isocyanate compound having an alicyclic structure is at least one selected from the group consisting of hydrogenated xylylene diisocyanate, a derivative of hydrogenated xylylene diisocyanate, 4,4′-methylenebis(cyclohexyl isocyanate), an isomer of 4,4′-methylenebis(cyclohexyl isocyanate), a derivative of 4,4′-methylenebis(cyclohexyl isocyanate), and a derivative of an isomer of 4,4′-methylenebis(cyclohexyl isocyanate).

<7> The adhesive composition according to any one of <1> to <6>, further comprising (C) an aliphatic isocyanate compound not having an alicyclic structure, and/or a derivative thereof.

<8> The adhesive composition according to <7>, wherein the aliphatic isocyanate compound not having an alicyclic structure is a compound having a linear alkyl group with 4 to 18 carbon atoms.

<9> The adhesive composition according to <5> or <6>, wherein the derivative of the isocyanate compound having an alicyclic structure is a compound containing at least one bond selected from the group consisting of an isocyanurate bond, a biuret bond, a urethane bond and an allophanate bond.

<10> The adhesive composition according to <8>, wherein the derivative of the aliphatic isocyanate compound not having an alicyclic structure is a compound containing at least one bond selected from the group consisting of an isocyanurate bond, a biuret bond, a urethane bond and an allophanate bond.

<11> The adhesive composition according to any one of <1> to <10>, wherein (A) the polyolefin is a polyolefin that has been graft-modified with an acid anhydride group-containing monomer or with an acidic group-containing monomer and an acid anhydride group-containing monomer, and a graft amount of the acid anhydride group-containing monomer is from 0.10 to 30% by weight.

<12> The adhesive composition according to any one of <1> to <11>, wherein (A) the polyolefin is a polyolefin that has been graft-modified with an esterified product of an alkyl alcohol having 8 to 18 carbon atoms and (meth)acrylic acid, and a graft amount thereof is from 0.10 to 20% by weight.

<13> The adhesive composition according to any one of <1> to <12>, wherein the (A) polyolefin has a weight average molecular weight of from 15,000 to 200,000 and a melting point of from 50 to 110° C.

<14> A thermally fusible member, comprising: an adhesive layer obtained by curing the adhesive composition according to any one of <1> to <13>; a metal layer bonded to one surface side of the adhesive layer; and a thermally fusible resin layer bonded to another surface side of the adhesive layer.

<15> A packaging material for a lithium ion battery, comprising the thermally fusible member according to <14>.

### Advantageous Effects of Invention

According to the present invention, it is possible to provide an adhesive composition that has a long working life even when it is cured using a cross-linking agent, and a thermally fusible member using the same.

### BRIEF DESCRIPTION OF DRAWINGS

FIG. 1 is a schematic perspective view showing one example of a thermally fusible member of the present invention.

FIG. 2 is a schematic perspective view showing another example of the thermally fusible member of the present invention.

FIG. 3 is a diagram showing measurement results of dynamic viscoelasticity in Examples 2-1, 2-2, 2-4 and 2-5.

### DESCRIPTION OF EMBODIMENTS

(Adhesive Composition)

The adhesive composition of the present invention includes an organic solvent, (A) a polyolefin that has an acid anhydride group and that is soluble in the organic solvent, and a cross-linking agent, in which a ring-opening ratio of an anhydrous ring of the acid anhydride group in (A) the polyolefin is from 0 to 60%.

As a result of intensive research by the present inventors, it has been found that the above-described configuration makes it possible to provide an adhesive composition that has a long working life even when cured using a cross-linking agent.

While the mechanism of action of the excellent effect obtained thereby is not clear, it is assumed to be as follows.

Including an organic solvent, (A) a polyolefin that has an acid anhydride group and that is soluble in the organic solvent, and a cross-linking agent, and configuring the ring-opening ratio of the anhydrous ring of the acid anhydride group in (A) the polyolefin to from 0 to 60/o make it possible, due to the ring-opening ratio of from 0 to 60%, to obtain an adhesive composition in which the initial curing reaction between (A) the polyolefin and the cross-linking agent is appropriately suppressed even when cured using a cross-linking agent, and which has a long working life (the period during which an operation such as coating can be performed after mixing with the curing agent).

A preferable first embodiment of the adhesive composition of the present invention includes an organic solvent, (A) a polyolefin that has an acid anhydride group and that is soluble in the organic solvent, and an isocyanate compound, in which a ring-opening ratio of an anhydrous ring of the acid anhydride group is from 5 to 60%.

In the preferable first embodiment of the adhesive composition of the present invention, the isocyanate compound is preferably (B) an isocyanate compound having an alicyclic structure and/or a derivative thereof, and preferably further includes (C) an aliphatic isocyanate compound not having an alicyclic structure and/or a derivative thereof.

According to the preferable first embodiment of the adhesive composition of the present invention, curability is excellent even when metal-based members, or polyolefin-based members through which water does not easily pass, are adhered, sufficient working life can be obtained even after adding the curing agent, adhesiveness at high temperature is excellent, and the composition can be favorably used for a packaging material for lithium ion batteries.

For conventional adhesive compositions, in the case of an adhesive composition in which a polyfunctional isocyanate compound is used as a curing agent for a polyolefin having an acid anhydride group, long-term curing was required until full hardening depending on the type of adherend and, even after hardening, there were cases in which the adhesive layer would peel off (delamination) at high temperature.

Usually, a curing agent composed of a polyfunctional isocyanate compound is often added excessively with respect to an equivalent amount of an acid anhydride group of the polyolefin having the acid anhydride group. Therefore, even in a high temperature and high humidity environment, curing has required three to seven days until full hardening depending on the conditions, which has been problematic in terms of productivity being capped. In addition, in a case of adhesion in winter when humidity is low, full hardening was not achieved under normal curing conditions, which also resulted in delamination.

For conventional adhesive compositions, it is thought that the cause of delamination at high temperature is that the crosslinking density of the cured adhesive layer is insufficient.

According to the preferable first embodiment of the adhesive composition of the present invention, the working life is long even when a polyfunctional isocyanate compound is used as the curing agent, and curability is excellent and adhesiveness even at high temperature is excellent even when metal-based members, or polyolefin-based members through which water does not easily pass, are adhered.

A preferable second embodiment of the adhesive composition of the present invention includes an organic solvent, (A) a polyolefin that has an acid anhydride group and that is soluble in the organic solvent, and a cross-linking agent, in which the ring-opening ratio of an anhydrous ring of the acid anhydride group in the polyolefin (A) is from 0 to 20%.

According to the preferable second embodiment of the adhesive composition of the present invention, sufficient working life can be obtained even after adding the curing agent, the liquid stability of the adhesive composition is excellent, high adhesive strength is obtained, and the composition can be favorably used for a packaging material for lithium ion batteries.

According to the preferable second embodiment of the adhesive composition of the present invention, since the ring-opening ratio is from 0 to 20%, sufficient working life can be obtained even after adding the curing agent, and further, the liquid stability of the adhesive composition containing the cross-linking agent is improved, adhesive strength is excellent, the obtained adhered product has excellent electrolyte resistance, and the composition can be favorably used for a packaging material for lithium ion batteries.

In the present invention, when simply referring to “the adhesive composition of the present invention”, needless to say, this encompasses both the preferable first embodiment of the adhesive composition of the present invention and the preferable second embodiment of the adhesive composition of the present invention.

In the present invention, “(A) polyolefin” or the like is referred to as “component (A)” or the like.

Hereinafter, a component (A), a cross-linking agent containing a component (B) and a component (C), an organic solvent, other components, ring-opening of an anhydrous ring, an adhesive composition, a method of producing an adhesive composition, a thermally fusible member, a method of producing a thermally fusible member, and applications thereof, will be described.

In addition, in the present specification, acrylic acid and/or methacrylic acid is referred to as (meth)acrylic acid.

1. Component (A)

The component (A) is a polyolefin that has an acid anhydride group, and that may have an acid anhydride group and an acidic group.

As the component (A), a polyolefin that is modified with an acid anhydride group-containing monomer, or with an acidic group-containing monomer and an acid anhydride group-containing monomer, is preferable in terms of having a high room-temperature peel strength and a high high-temperature peel strength.

Specific examples of the monomer unit configuring the polyolefin of the component (A) include ethylene, propylene, and α-olefins such as 1-butene, isobutylene, 1-hexene and 1-octene. As the α-olefin, an α-olefin having 2 to 6 carbon atoms is preferable. Among these, ethylene, propylene and 1-butene are preferable because they can improve the high-temperature peel strength and electrolyte resistance when a poorly adhesive non-polar polyolefin resin such as crystalline polyethylene or polypropylene is used as an adherend.

Preferable polyolefins as raw materials for the component (A) include polyethylene, polypropylene, a random copolymer of propylene and ethylene, a block copolymer of propylene and ethylene, a random copolymer of ethylene and an α-olefin, a block copolymer of ethylene and an α-olefin, a random copolymer of propylene and an α-olefin, and a block copolymer of propylene and an α-olefin. Examples of the α-olefin include 1-butene, isobutylene, 1-hexene and 1-octene.

Among these, when a poorly adhesive non-polar polyolefin resin such as crystalline polyethylene or polypropylene is used as an adherend, a polypropylene-based polymer such as a propylene-ethylene copolymer, a propylene-1-butene copolymer, and a propylene-ethylene-1-butene copolymer is more preferable in terms of being able to improve high-temperature peel strength and electrolyte resistance. Further, it is particularly preferable that the propylene unit in the polyolefin is 50% by weight or more.

Further, in the preferable second embodiment of the adhesive composition of the present invention, the content of a monomer unit consisting of 1-butene in (A) the polyolefin is, from the viewpoints of peel strength and high-temperature peel strength, preferably from 5 to 40 mol %, and more preferably from 10 to 30 mol %, with respect to all the monomer units configuring (A) the polyolefin.

Specific examples of the acidic group include a carboxylic acid group, a sulfonic acid group, and a phosphoric acid group and, among these, a carboxylic acid group is preferable in terms of ease of modification.

Specific examples of the acid anhydride group include a carboxylic acid anhydride group, a sulfonic acid anhydride group, and a phosphoric acid anhydride group and, among these, a carboxylic acid anhydride group is preferable in that the raw materials are readily available and modification is easy.

As the modification method, a known method can be adopted. Examples thereof include graft modification which allows an acid anhydride group-containing monomer, or an acidic group-containing monomer and an acid anhydride group-containing monomer to addition-react with a polyolefin, in the presence of a known radical polymerization initiator such as an organic peroxide or an aliphatic azo compound in a state of being melt-kneaded or in an organic solvent. Further, examples include a method of copolymerizing an acid anhydride group-containing monomer, or an acidic group-containing monomer and an acid anhydride group-containing monomer, with an olefin.

The component (A) may be further graft-modified with a (meth)acrylic acid alkyl ester. As the (meth)acrylic acid alkyl ester, an esterified product of an alkyl alcohol having 8 to 18 carbon atoms and (meth)acrylic acid (hereinafter, referred to as a “(meth)acrylic acid long-chain alkyl ester”) is preferable in terms of being able to improve the stability of the adhesive composition when it is made into a solution.

In order to improve the graft amount of the acidic group-containing monomer, the acid anhydride group-containing monomer, and the (meth)acrylic acid long-chain alkyl ester in the component (A), it is preferable to use an organic peroxide such as benzoyl peroxide, dicumyl peroxide, lauroyl peroxide, di-t-butyl peroxide, 2,5-dimethyl-2,5-di(t-butylperoxy)hexane, and cumene hydroperoxide, and a reaction aid and a stabilizer for adjusting resin stability can be used.

Specific examples of the reaction aid include styrene, o-methylstyrene, p-methylstyrene, α-methylstyrene, divinylbenzene, hexadiene and dicyclopentadiene.

Specific examples of the stabilizer include hydroquinone, benzoquinone and a nitrosophenyl hydroxy compound.

1-1. Acidic Group-Containing Monomer

Examples of the acidic group-containing monomer used as a raw material for the component (A) include compounds having an ethylenic double bond, a carboxylic acid group, and the like in the same molecule, such as various unsaturated monocarboxylic acid compounds, unsaturated dicarboxylic acid compounds, and unsaturated tricarboxylic acid compounds.

Specific examples of the unsaturated monocarboxylic acid compound include acrylic acid, methacrylic acid, crotonic acid and isocrotonic acid.

Specific examples of the unsaturated dicarboxylic acid compound include maleic acid, itaconic acid, citraconic acid, tetrahydrophthalic acid, nasic acid and endic acid.

Examples of the unsaturated tricarboxylic acid compound include aconitic acid.

As the acidic group-containing monomer, an unsaturated dicarboxylic acid compound and an unsaturated tricarboxylic acid compound are preferable, and itaconic acid, maleic acid, and aconitic acid are particularly preferable in terms of ease of modification and excellent adhesiveness.

These acidic group-containing monomers may be used singly, or in combination of two or more thereof.

In a case in which a portion of the acidic group-containing monomer used for modification remains unreacted, it is preferable to use, as the component (A), a component from which the unreacted acidic group-containing monomer has been removed by a known method such as heat distillation or reprecipitation purification in order to suppress any adverse effects on adhesive strength.

In a case in which the component (A) is a polyolefin that has been graft-modified with an acidic group-containing monomer, the graft amount thereof is preferably from 0.10 to 30% by weight. In terms of being able to maintain the solubility of the adhesive composition in a solvent and the adhesiveness to a material such as a metal adherend, 0.10% by weight or more is preferable, and 0.50% by weight or more is more preferable. In addition, in terms of being able to obtain sufficient adhesiveness, 30% by weight or less is preferable, 20% by weight or less is more preferable, and 10% by weight or less is particularly preferable.

The graft amount of the acidic group-containing monomer can be measured by a known method. For example, it can be determined by an alkaline titration method or Fourier transform infrared spectroscopy.

1-2. Acid Anhydride Group-Containing Monomer

Examples of the acid anhydride group-containing monomer used as a raw material for the component (A) include a compound having an ethylenic double bond, a carboxylic acid anhydride group, and the like in the same molecule, and an acid anhydride of the unsaturated monocarboxylic acid compound, an acid anhydride of the unsaturated dicarboxylic acid compound, and an acid anhydride of the unsaturated tricarboxylic acid compound.

Specific examples of the acid anhydride of the unsaturated monocarboxylic acid compound include acrylic acid anhydride, methacrylic acid anhydride, crotonic acid anhydride, and isocrotonic acid anhydride.

Specific examples of the acid anhydride of the unsaturated dicarboxylic acid compound include maleic acid anhydride, itaconic acid anhydride, citraconic acid anhydride, tetrahydrophthalic acid anhydride, nasic acid anhydride, and endic acid anhydride.

Specific examples of the acid anhydride of the unsaturated tricarboxylic acid compound include aconitic acid anhydride.

As the acid anhydride group-containing monomer, an acid anhydride of the unsaturated dicarboxylic acid compound and an acid anhydride of the unsaturated tricarboxylic acid compound are preferable, and itaconic acid anhydride, maleic acid anhydride, and aconitic acid anhydride are particularly preferable in terms of ease of modification and excellent adhesiveness.

These acid anhydride group-containing monomers may be used singly, or in combination of two or more thereof.

In a case in which a portion of the acid anhydride group-containing monomer used for modification remains unreacted, it is preferable to use, as the component (A), a component from which the unreacted acid anhydride group-containing monomer has been removed by a known method such as heat distillation or reprecipitation purification in order to suppress any adverse effects on adhesive strength.

In a case in which the component (A) is a polyolefin that has been graft-modified with an acid anhydride group-containing monomer, the graft amount thereof is preferably from 0.10 to 30% by weight. In terms of being able to maintain the solubility of the adhesive composition in a solvent and the adhesiveness to a material such as a metal adherend, 0.10% by weight or more is preferable, and 0.50% by weight or more is more preferable. In addition, in terms of being able to obtain sufficient adhesiveness, 30% by weight or less is preferable, 20% by weight or less is more preferable, and 10% by weight or less is particularly preferable.

The graft amount of the acid anhydride group-containing monomer can be measured by a known method. For example, it can be determined by an alkaline titration method or Fourier transform infrared spectroscopy.

In the preferable first embodiment of the adhesive composition of the present invention, the acid anhydride group contained in the component (A) is characterized in that the anhydrous ring is opened at a ratio of from 5 to 60% of the number of acid anhydride groups. From the viewpoint that the cross-linking reaction with the curing agent can be promoted, 5% or more is preferable, 20% or more is more preferable, more than 20% is still more preferable, and 40% or more is particularly preferable. Further, in order to obtain a sufficient working life after blending with the curing agent, the ratio is set as 60% or less.

In the preferable second embodiment of the adhesive composition of the present invention, the ring-opening ratio of an anhydrous ring of the acid anhydride group in (A) the polyolefin is preferably from 0 to 20%, more preferably from 0 to 15%, still more preferably from 0 to 12%, and particularly preferably from 0 to 10%, from the viewpoints of liquid stability and adhesive strength.

Further, in the preferable second embodiment of the adhesive composition of the present invention, the ring-opening ratio of an anhydrous ring of the acid anhydride group in (A) the polyolefin is preferably more than 0%, more preferably 1% or more, still more preferably 5% or more, and particularly preferably 7% or more, from the viewpoint of adhesive strength.

The ring-opening ratio of an anhydrous ring of the acid anhydride group in (A) the polyolefin is measured by the following method.

The quantitation of carboxyl groups or anhydrides thereof can be measured by a method such as an infrared absorption (IR) spectrum, an NMR (nuclear magnetic resonance), and a titration. In an NMR, since there is less grafted acid compared to the polymer main chain, the degree of error is large and it is difficult to compare acid anhydride rings with ring-opened counterparts. In a titration method, the polymer is precipitated during the titration and the degree of error is large. Therefore, analysis according to an infrared absorption spectrum is preferable.

From the measured infrared absorption spectrum, the height of an absorption peak derived from the acid anhydride group is calibrated based on an absorption peak that is not affected by the acid anhydride group or water, and the ring-opening ratio can be estimated by comparing the calibrated height of the acid anhydride group.

As a method for obtaining the component (A) in which the anhydrous ring of the acid anhydride group is opened, a method of opening the ring during the production of the component (A), and a method of opening the anhydrous ring of the acid anhydride group by hydrolysis or the like after the production of the component (A), are available.

As the method of ring-opening during production, a method of modification using an acid anhydride group-containing monomer comprising an anhydrous ring that has been opened, a method of adding water, alcohol, an amine compound, or the like in combination with the acid anhydride group-containing monomer, and a method of curing by exposure to air after production, are available.

As the method of opening the ring of the acid anhydride group by hydrolysis or the like, a method of dissolving the component (A) in a solvent, then adding a predetermined amount of water, alcohol or an amine compound, and heating, and a method of dissolving the component (A) after long-term exposure to humidifying conditions, are available. As a method of quantitatively opening the ring of the acid anhydride group, a method of adding a predetermined amount of water, alcohol, an amine compound, or the like, and heating, is preferable.

1-3. (Meth)Acrylic Acid Long-Chain Alkyl Ester

Specific examples of the (meth)acrylic acid long-chain alkyl ester that is a raw material for the component (A) include octyl (meth)acrylate, lauryl (meth)acrylate, tridecyl (meth)acrylate, and stearyl (meth)acrylate and, from the viewpoint that adhesiveness can be significantly improved when a poorly adhesive non-polar polyolefin resin is used as an adherend, octyl (meth)acrylate, lauryl (meth)acrylate, and tridecyl (meth)acrylate are preferable.

The graft amount of the (meth)acrylic acid long-chain alkyl ester in the component (A) is preferably from 0.10 to 20% by weight. In terms of being able to favorably maintain solubility of the component (A) in a solvent, compatibility with other resins, and adhesiveness, 0.10% by weight or more is preferable. In addition, in terms of being able to maintain favorable adhesiveness, 20% by weight or less is preferable, 10% by weight or less is more preferable, and 5.0% by weight or less is particularly preferable.

The graft amount of the (meth)acrylic acid long-chain alkyl ester can be measured by a known method. For example, it can be determined by Fourier transform infrared spectroscopy or by a ¹H-NMR method.

In the present invention, depending on the purpose, monomers (hereinafter referred to as “other monomers”) other than the acidic group-containing monomer, the acid anhydride group-containing monomer, and the (meth)acrylic acid long-chain alkyl ester can be used in combination to the extent that the characteristics of the present invention are not impaired.

Specific examples of the other monomers include a (meth)acrylic acid ester other than the (meth)acrylic acid long-chain alkyl ester, such as hydroxyethyl (meth)acrylate, benzyl (meth)acrylate, glycidyl (meth)acrylate and an isocyanate-containing (meth)acrylic acid, and an unsaturated monomer that is copolymerizable with olefins, such as styrene, cyclohexyl vinyl ether, and dicyclopentadiene.

Using other monomers in combination makes it possible to further improve adhesiveness and solubility in solvents, as well as the graft amount of the acidic group-containing monomer, the acid anhydride group-containing monomer and the (meth)acrylic acid long-chain alkyl ester. Further, it is desirable that the usage amount of other monomers does not exceed the total graft amount of the acidic group-containing monomer, the acid anhydride group-containing monomer and the (meth)acrylic acid long-chain alkyl ester.

Depending on the purpose, the component (A) may be a polyolefin that has an acidic group and/or an acid anhydride group and that has an ethylenically unsaturated group, to the extent that the characteristics of the present invention are not impaired.

Examples of the method for introducing an ethylenically unsaturated group into the component (A) include a method of adding, to the acidic group and/or the acid anhydride group, a hydroxyl group-containing ethylenically unsaturated monomer such as hydroxylethyl (meth)acrylate and an epoxy group-containing ethylenically unsaturated monomer such as glycidyl (meth)acrylate.

The weight average molecular weight of the component (A) is preferably from 15,000 to 200,000. In terms of being able to improve room-temperature peel strength and electrolyte resistance, 15,000 or more is preferable, 30,000 or more is more preferable, and 40,000 or more is particularly preferable. In addition, in terms of being able to improve solubility in an organic solvent contained in the adhesive composition, 200,000 or less is preferable, and 150,000 or less is more preferable.

In the present invention, the weight average molecular weight is a value obtained by polystyrene conversion of a molecular weight measured by gel permeation chromatography.

The melting point of the component (A) is preferably from 50 to 110° C. In terms of being able to obtain sufficient peel strength, 50° C. or higher is preferable, and 60° C. or higher is more preferable. Further, 110° C. or lower is preferable, and 100° C. or lower is more preferable, in terms of being able to obtain sufficient storage stability at low temperature.

The melt flow rate of the component (A), particularly the component (A) in the second embodiment is preferably from 50 to 1000 g/10 min (190° C./2.17 kg), and more preferably from 100 to 800 g/10 min (190° C./2.17 kg), from the viewpoints of coatability and high-temperature peel strength.

The melt flow rate in the present invention is measured using a melt indexer G-02 manufactured by Toyo Seiki Seisaku-sho Ltd. under automatic measurement mode at a furnace temperature of 190° C. and a load of 2.17 kg.

The acid value of the component (A) in the present invention is taken as the acid value in a case in which all the acid anhydride rings have opened to become carboxyl groups, and the acid value is preferably from 5 to 50 mgKOH/g, and more preferably from 10 to 40 mgKOH/g, from the viewpoints of adhesive strength and liquid stability of the adhesive composition.

The acid value in the present invention can be measured by neutralization titration or by infrared absorption spectrum, as described later.

In the adhesive composition of the present invention, the component (A) may be used singly, or in combination of two or more thereof.

The content amount of the component (A) is preferably from 70 to 99% by weight and more preferably from 80 to 99% by weight with respect to 100% by weight of the solid content of the adhesive composition, in view of being excellent in high-temperature peel strength and electrolyte resistance.

2. Cross-Linking Agent

The adhesive composition of the present invention includes a cross-linking agent.

As the cross-linking agent, any cross-linking agent capable of reacting with the acid anhydride group in the component (A) to achieve cross-linking may be used, and known cross-linking agents can be used.

Examples of the cross-linking agent include a polyfunctional isocyanate compound, a polyfunctional epoxy compound, a polyfunctional carbodiimide compound, a polyfunctional oxazoline compound, and a polyfunctional aziridine compound.

A monofunctional compound thereof can also be used in combination for the purpose of adjusting the viscosity of the solution and adjusting the elastic modulus or elongation of the cured product.

Of these, an isocyanate compound is preferable from the viewpoints of curability and adhesive strength.

As the isocyanate compound, (B) an isocyanate compound of a hydrocarbon having an alicyclic structure and/or a derivative thereof, or (C) an isocyanate compound of a saturated aliphatic hydrocarbon not having an alicyclic structure and/or a derivative thereof, can be preferably used.

The component (B) has, due to favorable compatibility with the component (A), has effects of increasing the cross-linking density of a cured product to improve the high-temperature peel strength and reducing swelling of the adhesive composition due to an electrolyte or the like, and the component (C) has an effect of improving adhesion to an adherend.

2-1. Component (B)

The component (B) is an isocyanate compound having an alicyclic structure (hereinafter referred to as “component (b)”) and/or a derivative thereof.

Specific examples of the component (b) include: hydrogenated xylylene diisocyanate (encompassing structural isomers 1,2-bis(isocyanate methyl)cyclohexane, 1,3-bis(isocyanate methyl)cyclohexane, 1,4-bis(isocyanate methyl)cyclohexane, and stereoisomers thereof); 4,4′-methylene bis(cyclohexyl isocyanate) and structural isomers thereof (2,2′-methylene bis(cyclohexyl isocyanate) and 2,4′-methylene bis(cyclohexyl isocyanate)); stereoisomers of hydrogenated xylylene diisocyanate, 4,4′-methylene bis(cyclohexyl isocyanate) and structural isomers thereof; norbornane dimethyl isocyanate; and isophorone diisocyanate (encompassing isomers).

As the component (b), in terms of being highly effective in improving high-temperature peel strength, a diisocyanate compound having at least one alicyclic structure is preferable, and among these, hydrogenated xylylene diisocyanate, 4,4′-methylene bis(cyclohexyl isocyanate), and isomers thereof are particularly preferable.

As the derivative of the component (b), a compound having an isocyanurate bond, a biuret bond, a urethane bond and/or an allophanate bond is preferable, and a compound having an isocyanurate bond is particularly preferable.

The derivative of the component (b) may have a urea bond and/or a uretdione bond.

As the component (b), commercially available products can be used.

Examples of isocyanate compounds having an alicyclic structure include HMDI (manufactured by Wanhua Chemical Group Co., Ltd.), Desmodur W (manufactured by Sumika Covestro Urethane Co., Ltd.), Fortimo (manufactured by Mitsui Chemicals, Inc.), Takenate 600 (manufactured by Mitsui Chemicals, Inc.), Cosmonate NBDI (manufactured by Mitsui Chemicals, Inc.), and IPDI (manufactured by Beyond Industries Limited). Examples of derivatives of isocyanate compounds include, as commercial products of compounds having an isocyanurate bond, Desmodur Z4470BA (manufactured by Sumika Covestro Urethane Co., Ltd.) and Duranate T4900-70B (manufactured by Asahi Kasei Corporation).

Examples of commercially available compounds having an allophanate bond include Desmodur XP2565 (manufactured by Sumika Covestro Urethane Co., Ltd.).

Examples of commercially available compounds having a urethane bond include Takenate D-140N (manufactured by Mitsui Chemicals, Inc.), which is an adduct of isophorone diisocyanate and trimethylol propane, and Vestanat EP-DC1241 (manufactured by Evonik Japan Co., Ltd.), which is a monoadduct of isophorone diisocyanate and hydroxyethyl acrylate.

2-2. Component (C)

The component (C) is an aliphatic isocyanate compound not having an alicyclic structure (hereinafter referred to as “component (c)”) and/or a derivative thereof.

The component (c) preferably has a linear alkyl group having 4 to 18 carbon atoms in terms of being highly effective in improving the peel strength of the adhesive composition at room temperature.

Specific examples of the component (c) include hexamethylene diisocyanate, pentamethylene diisocyanate and tetramethylene diisocyanate and, as the component (c), hexamethylene diisocyanate is preferable in terms of being highly effective in improving adhesion to an adherend.

As the derivative of the component (c), a compound having an isocyanurate bond, a biuret bond, a urethane bond and/or an allophanate bond is preferable, and a compound having an isocyanurate bond is particularly preferable in terms of being highly effective in improving adhesion to an adherend and being able to improve room-temperature peel strength and electrolyte resistance.

The derivative of the component (c) may have a urea bond and/or a uretdione bond.

As the derivative of the component (c), commercially available products can be used.

Examples of commercially available products of compounds having an isocyanurate bond include Duranate TPA-100 (manufactured by Asahi Kasei Corporation), Duranate MFA-75B (manufactured by Asahi Kasei Corporation), Duranate TUL-100 (manufactured by Asahi Kasei Corporation), Duranate TSA-100 (manufactured by Asahi Kasei Corporation), Coronate HX (manufactured by Tosoh Corporation), and Takenate D-170N (manufactured by Mitsui Chemicals, Inc.).

Examples of commercially available products of compounds having a biuret bond include Duranate 24A-100 (manufactured by Asahi Kasei Corporation), Duranate 21S-75E (manufactured by Asahi Kasei Corporation), Takenate D-165NN (manufactured by Mitsui Chemicals, Inc.), and Desmodur N3200 (manufactured by Sumika Covestro Urethane Co., Ltd.).

Examples of commercially available products of compounds having a urethane bond include Duranate P301-75E (manufactured by Asahi Kasei Corporation) and Sumidur HT (manufactured by Sumika Covestro Urethane Co., Ltd.), which are adducts of hexamethylene diisocyanate and trimethylolpropane.

Examples of commercially available products of compounds having an allophanate bond include Desmodur XP2580 (manufactured by Sumika Covestro Urethane Co., Ltd.).

The weight ratio of the component (A) and the isocyanate compound in the adhesive composition of the present invention is not particularly limited, and the equivalent ratio (NCO/COOH) of isocyanate groups in the isocyanate compound to carboxylic acid groups in the component (A) is preferably from 0.01 to 12.0. In terms of being able to exhibit excellent initial adhesiveness, 0.01 or more is preferable, 0.04 or more is more preferable, and 0.1 or more is particularly preferable. In addition, in terms of having sufficient cross-linking density and being able to form a cured product having excellent flexibility and the like, 12.0 or less is preferable, and 9.0 or less is more preferable.

As regards the NCO content ratio of the component (B) and the component (C) in the adhesive composition of the present invention, the ratio of the component (B) is preferably from 10 to 100% and the ratio of the component (C) is preferably from 0 to 90%, in a case in which the total content of the component (B) and the component (C) is 100%. In terms of having an effect of increasing the cross-linking density of a cured product to improve the high-temperature peel strength, the component (B) is preferably from 20 to 90%, and more preferably from 30 to 90%. In addition, in terms of being able to improve adhesion to an adherend, the component (C) is preferably from 10 to 80%, and more preferably from 10 to 70%.

In the adhesive composition of the present invention, the cross-linking agent may be used singly, or in combination of two or more thereof.

The content amount of the cross-linking agent is preferably from 1 to 50 parts by weight and more preferably from 5 to 30 parts by weight, with respect to the total amount of 100 parts by weight of the component (A) and the cross-linking agent, from the viewpoints of adhesive strength and high-temperature adhesive strength.

Further, the molar ratio of cross-linkable groups in the cross-linking agent/carboxyl groups in the component (A) (1 molar equivalent of acid anhydride group being considered as 2 molar equivalents of carboxyl group) contained in the adhesive composition of the present invention is preferably from 0.1 to 10, and more preferably from 0.5 to 6, from the viewpoints of adhesive strength and high-temperature adhesive strength.

3. Organic Solvent

In the adhesive composition of the present invention, the organic solvent is formulated for the purpose of dissolving the component (A).

Specific examples of organic solvents include aromatic organic solvents such as toluene and xylene, aliphatic organic solvents such as n-hexane, alicyclic organic solvents such as cyclohexane, methyl cyclohexane and ethyl cyclohexane, ketone-based organic solvents such as acetone and methyl ethyl ketone, alcohol-based organic solvents such as methanol and ethanol, ester-based organic solvents such as ethyl acetate and butyl acetate, and propylene glycol ether-based organic solvents such as propylene glycol methyl ether, propylene glycol ethyl ether, and propylene glycol-t-butyl ether.

In the adhesive composition of the present invention, the organic solvent may be used singly, or in combination of two or more thereof.

The organic solvent is preferably an organic solvent that can be easily volatilized and removed by heating or the like of the adhesive composition and, in particular, it is preferable to use a mixed solvent of an alicyclic organic solvent with an ester-based or ketone-based organic solvent.

In the adhesive composition of the present invention, the weight ratio of the organic solvent and the component (A) is not particularly limited, and may be determined depending on the type or the like of the organic solvent and the component (A).

The content of the component (A) is preferably from 5 to 25% by weight, and particularly preferably from 10 to 20% by weight, in a case in which the total of the organic solvent and the component (A) is 100% by weight. When the content is in such ranges, the adhesive composition can be easily applied to an adherend and workability is excellent.

4. Other Components

While the adhesive composition of the present invention includes the organic solvent, the component (A), and the cross-linking agent including the components (B) and (C), various other components can be formulated depending on the purpose.

Specific examples of other components include a curing catalyst, a styrene-based thermoplastic elastomer, a tackifier, an antioxidant, a hindered amine light stabilizer, a UV absorber, an antistatic agent, a flame retardant, a colorant, a dispersant, an adhesion-imparting agent, a defoamer, a leveling agent, a plasticizer, a lubricant, and filler.

Hereinafter, these components will be described.

As the other components described below, exemplified compounds may be used singly, or in combination of two or more thereof.

4-1. Curing Catalyst

A curing catalyst can be formulated for the purpose of promoting the cross-linking reaction between the component (A) and the isocyanate compound to obtain excellent adhesive performance.

From the viewpoints of ease of curing and adhesive performance, the adhesive composition of the present invention preferably further includes a curing catalyst and, as the curing catalyst, a tertiary amine, a metal carboxylate, a metal complex salt, and the like, are preferable.

Specific examples of the tertiary amine include a tetraalkylethylene diamine such as tetramethylethylene diamine, an N,N′-dialkylbenzylamine such as dimethylbenzylamine, triethylenediamine, pentamethyldiethylenetriamine, N-ethylmorphylin, N-methylmorphylin, 1-methyl-4-dimethylamine ethylpiperazine, and 1,8-diazabicyclo[5.4.0]undecene-7.

Examples of the metal carboxylate and the metal complex salt include: a metal carboxylate, for example, a metal acetate, a metal hexanoate, a metal octanate such as a metal 2-ethylhexanoate, a metal neodecanoate, a metal laurate, a metal stearate, and a metal oleate; and a metal complex salt such as a metal acetylacetonate. The metal is preferably one or more metals selected from Group 7, Group 12, or Group 14 of the Periodic Table of the Elements. These may be used singly or in combination of two or more thereof. Among these, from the viewpoint of adhesiveness in a case in which an adhesive layer formed from the adhesive composition of the present invention comes into contact with an electrolyte, a carboxylic acid salt or an acetylacetonate of any of tin, zinc, or manganese is more preferable. Specific examples include zinc neodecanoate, dibutyltin dilaurate, dioctyltin dilaurate, dioctyltin diacetate, dibutyltin maleate, zinc bis(neodecanoate), zinc bis(2-ethylhexanoate), zinc distearate, zinc (II) acetylacetoneate, and manganese bis(2-ethylhexanoate). Among these, from the viewpoint of balance between the adhesiveness, the electrolyte resistance and the heat resistance of the adhesive layer, dibutyltin dilaurate and dioctyltin dilaurate are more preferable.

As the curing catalyst, a tertiary amine, and a metal carboxylate or complex salt can also be used in combination.

The content ratio of the curing catalyst is preferably from 0.001 to 5 parts by weight with respect to the total amount of 100 parts by weight of the components (A) to (C). By setting the ratio of the curing catalyst to 0.001 parts by weight or more, acquisition of a sufficient catalytic effect is facilitated, and by setting the ratio of the curing catalyst to 5 parts by weight or less, it is possible to ensure the storage stability of the adhesive composition and the working life after formulating the curing agent.

4-2. Styrene-Based Thermoplastic Elastomer

A styrene-based thermoplastic elastomer can be formulated for the purpose of improving the adhesive strength.

Specific examples of the styrene-based thermoplastic elastomer include a styrene-based resin such as a styrene-butadiene copolymer, an epoxy-modified styrene-butadiene copolymer, a styrene-butadiene-styrene block copolymer, a styrene-ethylene/propylene-styrene block copolymer (hereinafter referred to as “SEPS”), a styrene-ethylene/butylene-styrene block copolymer (hereinafter referred to as “SEBS”), a styrene-isoprene/butadiene-styrene block copolymer, and a styrene-isoprene-styrene block copolymer, and these may not have an acidic group or an acid anhydride group, or may have an acidic group and/or an acid anhydride group, or may have an amino group.

As a modification method for introducing an acidic group and/or an acid anhydride group, a known method can be adopted. Examples thereof include graft modification such as melt-kneading the acidic group and/or acid anhydride group-containing monomer with the styrene-based resin in the presence of a radical polymerization initiator such as an organic peroxide or an aliphatic azo compound.

As a modification method for introducing an amino group, a known method can be adopted. Examples thereof include terminal modification such as adding an amino group-containing compound to a living terminal of the styrene-based resin obtained by living anionic polymerization, and graft modification such as melt-kneading an amine compound having an unsaturated bond such as 2-(1-cyclohexenyl)ethylamine with the styrene-based resin in the presence of a radical polymerization initiator such as an organic peroxide or an aliphatic azo compound.

Among these, SEPS and SEBS are preferable from the viewpoint that the adhesive strength can be improved.

4-3. Tackifier

A tackifier can be formulated for the purpose of improving the adhesive strength.

As the tackifier, known tackifiers can be used, and examples thereof include a polyterpene-based resin, a rosin-based resin, an aliphatic petroleum resin, an alicyclic petroleum resin, a copolymer-based petroleum resin and a hydrogenated petroleum resin.

Specific examples of the polyterpene-based resin include an α-pinene polymer, a β-pinene polymer, and a copolymer of these polymers with phenol, bisphenol A or the like.

Specific examples of the rosin-based resin include a natural rosin, a polymerized rosin, and an ester derivative thereof.

Specific examples of the aliphatic petroleum resin include a resin which is also called a C5-based resin and which is generally synthesized from the C5 fraction of petroleum. Specific examples of the alicyclic petroleum resin include a resin which is also called a C9-based resin and which is generally synthesized from the C9 fraction of petroleum.

Specific examples of the copolymer-based petroleum resin include a C5/C9 copolymer-based resin.

The hydrogenated petroleum resin is generally produced by hydrogenation of the respective petroleum resins described above.

The content amount of the tackifier is preferably from 1 to 20% by weight and more preferably from 1 to 10% by weight, with respect to 100% by weight of the adhesive composition, in terms of being excellent in hot water resistance.

5. Ring-Opening of Anhydrous Ring

It is possible to use water, an alcohol, a glycol ether or the like for the ring-opening of the anhydrous ring of the acid anhydride group. The alcohol is not particularly limited as long as it is a material that is classified as a general monohydric alcohol. Examples of the monohydric alcohol include methanol, ethanol, 1-propanol, 2-propanol, butanol, pentanol, hexanol, benzyl alcohol, allyl alcohol, and cyclohexanol. Examples of the glycol ether include ethylene glycol monomethyl ether, ethylene glycol monoethyl ether, ethylene glycol monobutyl ether, diethylene glycol monomethyl ether, diethylene glycol monoethyl ether, diethylene glycol monopropyl ether, diethylene glycol monoisopropyl ether, diethylene glycol monobutyl ether, diethylene glycol monoisobutyl ether, diethylene glycol monobenzyl ether, triethylene glycol monomethyl ether, polyethylene glycol monomethyl ether, propylene glycol monomethyl ether, propylene glycol monobutyl ether, propylene glycol monopropyl ether, dipropylene glycol monomethyl ether, dipropylene glycol monopropyl ether, dipropylene glycol monoisopropyl ether, dipropylene glycol monobutyl ether, tripropylene glycol monomethyl ether, 1-methoxy-2-butanol, 2-methoxy-1-butanol, 2-methoxy-2-methylbutanol, and 2-(2-butoxyethoxy)ethanol.

6. Adhesive Composition

The adhesive composition of the present invention includes the organic solvent, the component (A), the cross-linking agent containing the components (B) and (C), and preferably further includes the curing catalyst.

The viscosity of the adhesive composition of the present invention at 25° C. is preferably from 10 to 5,000 mPa-s. The viscosity is preferably 10 mPa-s or more from the viewpoint of being excellent in coatability. Further, in terms of being excellent in leveling properties, the viscosity is preferably 5,000 mPa s or less and more preferably 1,000 mPa-s or less.

The adhesive composition of the present invention is favorable for adhesion between a polyolefin resin molded body and another member (a metal member, a resin member, and the like), and can be used for not only adhesion of polyolefin resin molded bodies, such as polyolefin resin films, with each other, but also adhesion between a polyolefin resin film and a metal foil made from aluminum or the like, adhesion between a polyolefin resin film and a metal layer of a composite film having a resin layer and the metal layer, and the like. The adhesive layer has high room-temperature peel strength and high high-temperature peel strength and is excellent in adhesiveness, and also has high electrolyte resistance. Therefore, the adhesive layer can be preferably used as a packaging material for lithium ion batteries.

7. Production Method of Adhesive Composition

The adhesive composition of the present invention can be produced by a known method.

Specific methods include a method in which a solution of the component (A) dissolved in an organic solvent is mixed with the other components excluding the isocyanate compound, and then the obtained mixture is mixed with the isocyanate compound. The temperature at the time of mixing is preferably 40° C. or lower, and more preferably from 10° C. to 30° C.

8. Thermally Fusible Member

The thermally fusible member of the present invention includes an adhesive layer obtained by curing the adhesive composition of the present invention, a metal layer bonded to one surface side of the adhesive layer, and a thermally fusible resin layer bonded to another surface side of the adhesive layer.

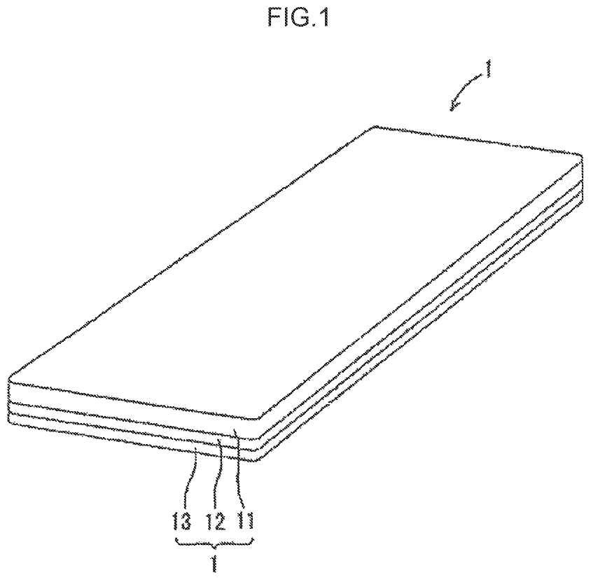

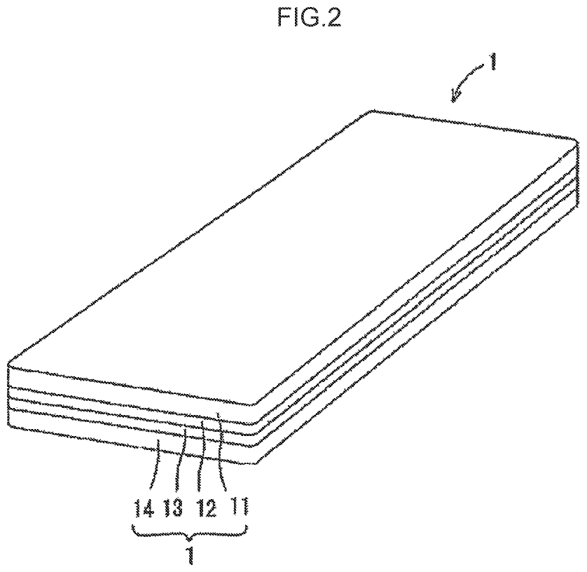

Schematic views of the thermally fusible member of the present invention are shown in FIGS. 1 and 2. A thermally fusible member 1 of FIG. 1 includes, in order, a thermally fusible resin layer 11, an adhesive layer 12, and a metal layer 13. Further, a thermally fusible member 1 of FIG. 2 includes, in order, a thermally fusible resin layer 11, an adhesive layer 12, a metal layer 13, and another layer 14.

The shape of the thermally fusible member of the present invention may be appropriately configured depending on the intended use or the like, and is not particularly limited; however, examples thereof include a film shape, a sheet shape, a plate shape, an angled shape, and a rod shape.

The thermally fusible resin layer is a layer including a resin that melts by heat and that can fusion-bond a material configuring a layer on one surface side with a material configuring a layer on another surface side. The thermally fusible resin layer is preferably a layer including a resin that melts at a temperature of from 50° C. to 200° C. Examples of the resin having such properties include a polyolefin resin, a polyamide resin, a polyester resin. Among these, a polyolefin resin is preferable because they can be thermally fusion-bonded with sufficient strength. Further, as the polyolefin resin, polypropylene is preferable. In particular, an unstretched polypropylene is more preferable because there is little dimensional change (shrinkage) when a thermally fusible member is used for integration with another member.

The thermally fusible resin layer may be a layer that includes, as necessary, an additive such as a lubricant, a filler, a heat stabilizer, an antioxidant, a UV absorber, an antistatic agent, a flame retardant, a colorant, a dispersant, and an adhesion-imparting agent.

The thickness of the thermally fusible resin layer changes depending on the material of the resin and the like, and is not particularly limited. For example, in the case of the layer including an unstretched polypropylene, the thickness is preferably from 10 to 200 μm, and more preferably from 20 to 100 μm. If the thickness of the layer including an unstretched polypropylene is from 10 to 200 μm, a thermally fusion-bonded composite product, such as a highly durable sealed container which is not easily damaged, can be obtained.

The adhesive layer is formed by curing the adhesive composition of the present invention. Although the thickness of the adhesive layer is not particularly limited, it is preferably from 1 to 20 μm, and particularly preferably from 2 to 10 μm. If the thickness of the adhesive layer is from 1 to 20 μm, it is easy to perform processing such as bending when the thermally fusible member is, for example, in a sheet shape.

The metal layer is a layer containing a metal or an alloy. Examples of the metal or alloy include aluminum, iron, titanium, magnesium, copper, nickel, chromium and other metals, and alloys thereof. Among these, aluminum is preferable since it has excellent workability. The thickness of the metal layer changes depending on the material and the like, and is not particularly limited. In the case that the metal layer is made from, for example, aluminum, the thickness is preferably from 20 to 100 μm, more preferably from 20 to 80 μm, and even more preferably from 30 to 60 μm.

In the case that the thermally fusible member of the present invention includes a metal layer, another layer 14 can be provided on the surface of the metal layer 13 as shown in FIG. 2. The material constituting the other layer preferably includes a resin, from the viewpoint of protecting the metal layer. That is, the other layer is preferably a resin layer. The resin is not particularly limited, and can be a polyamide resin, a polyester resin or the like. Although the transparency of the resin layer is not particularly limited, when the resin layer is transparent or translucent, an excellent appearance can be obtained in a case in which the thermally fusible member is made into a sealed container or the like as a thermally fusion-bonded composite product. Although the thickness of the other layer is not particularly limited, it is preferably from 30 to 60 μm, and more preferably from 30 to 50 μm.

The thermally fusible member using the adhesive composition of the present invention has high room-temperature peel strength and high high-temperature peel strength, is excellent in adhesiveness and, due to having excellent resistance to a solvent such as an electrolyte, can prevent deterioration of contents while maintaining structure.

In the case of use as a packaging material for lithium ion batteries, the adhesiveness and the like can be maintained in temperature change in battery storage or in a usage environment, in particular, in a chemical temperature rise of materials constituting the battery associated with charging or discharging, in summer, or in a temperature range higher than room temperature in automobiles or the like.

9. Method of Producing Thermally Fusible Member

The method of producing the thermally fusible member shown in FIG. 1 is as follows.

(1) A method including applying the adhesive composition to a surface of a metal foil, a metal film or the like for forming the metal layer 13, then removing the organic solvent contained in the composition to form the adhesive layer 12, and subsequently bringing the surface of the thus-formed adhesive layer 12 into contact with a resin film for forming the thermally fusible resin layer 11 (hereinafter referred to as “thermally fusible resin film”) and pressure bonding them while heating.

(2) A method including applying the adhesive composition to the surface of the thermally fusible resin film, then removing the organic solvent contained in the composition to form the adhesive layer 12, and subsequently bringing the surface of the thus-formed adhesive layer 12 into contact with a metal foil or the like for forming the metal layer 13 and pressure bonding them while heating.

Further, the method of producing the thermally fusible member shown in FIG. 2 is as follows.

(3) A method including applying the adhesive composition to the surface of the metal layer 13 of a composite film that includes a resin layer constituting the other layer 14 and the metal layer 13 formed on one surface side of the resin layer by vapor deposition or the like, then removing the organic solvent contained in the composition to form the adhesive layer 12, and subsequently bringing the surface of the thus-formed adhesive layer 12 into contact with the thermally fusible resin film and pressure bonding them while heating.

(4) A method including applying the adhesive composition to the surface of the thermally fusible resin film, then removing the organic solvent contained in the composition to form the adhesive layer 12, and subsequently bringing the surface of the thus-formed adhesive layer 12 into contact with the surface of the metal layer 13 of a composite film that includes a resin layer constituting the other layer 14 and the metal layer 13 formed on one side of the resin layer by vapor deposition or the like and pressure bonding them while heating.

(5) A method of extrusion molding a film for forming the other layer 14 on the surface of the metal layer 13 of the layered body obtained by method (1) or (2) above.

The adhesive composition is often applied to a material for forming a metal layer such as a metal foil, or a surface of a metal layer of a composite film that includes the metal layer and another layer (resin layer), but is not particularly limited to this. In a case in which a metal foil is used, it is preferable to use an aluminum foil having a thickness of from 20 to 100 μm. Due to this, it is possible to easily form a thermally fusible member in which damage is suppressed. Further, in a case in which a composite film is used, it is preferable that the metal layer contains aluminum and the other layer (resin layer) contains a polyamide resin, a polyester resin or the like. In addition, in a case in which the thermally fusible member shown in FIG. 2 is produced without using a composite film, that is, in a case in which the above method (5) is employed, it is preferable to use a film including a polyamide resin, a polyester resin or the like as a film for forming the other layer 14.

As the thermally fusible resin film, a polyolefin resin film, a polyamide resin film, a polyester resin film and the like can be used. These resin films can be films obtained by film forming methods such as an extrusion method, a cast molding method, a T-die method, and an inflation method. The thickness of the thermally fusible resin film is preferably from 10 to 200 μm. In the present invention, a polyolefin resin film is preferable from the viewpoint that it is possible to easily perform thermal fusion for completing the thermally fusible member and thermal fusion at the time of producing a thermally fusion-bonded composite product, and an unstretched polypropylene film is particularly preferable from the viewpoint that a thermally fusion-bonded composite product such as a sealed container that is difficult to damage and has excellent durability can be obtained. In the case of using this unstretched polypropylene film, the thickness is preferably from 10 to 200 μm, and more preferably from 20 to 100 μm.

The adhesive composition can be applied by a conventionally known method, and can be applied by using, for example, a bar coater, a gravure coater or the like. The thickness of the coating film and the drying temperature thereof are not particularly limited. The drying temperature of the coating film is not particularly limited, and is preferably from 30° C. to 100° C. from the viewpoint of workability.

As described above, the dried coating film generally has tackiness and adhesiveness and thus can bond two members without heating. However, in the case of producing the thermally fusible member of the present invention, a method using pressure bonding or the like while heating to a temperature taking into account the melting point, melt viscosity and the like of the resin component based on the component (A) can be applied. As for heating conditions and pressure bonding conditions, for example, the temperature is 80° C., the pressure is 0.3 MPa, and a time period of the pressure bonding is 2 seconds.

In addition, conditions for promoting the cross-linking reaction between the component (A) and the isocyanate compound to complete the thermally fusible member (hereinafter referred to as “aging conditions”) are not particularly limited, and it is preferable to set the conditions according to the material of the metal foil, the material of the thermally fusible resin film, the melting temperature and the like, the composition and the like of the adhesive layer. As for aging conditions, heating may be performed at 40° C. for about 3 to 7 days, and a polyolefin having an acidic group and/or an acid anhydride group and an ethylenically unsaturated group may be used as the component (A) to perform curing by active energy rays such as ultraviolet rays and electron beams in combination with heating, in order to shorten the aging time.

10. Applications

The thermally fusible member of the present invention can be used in various industrial products in the fields of electricity, automobiles and other industrial fields.

Examples of applications in electrical fields include packaging materials for secondary batteries such as lithium ion batteries and lithium ion polymer batteries, decoration by attaching decorative sheets in mobile devices, housings of television sets, housings of household electrical appliances and the like, adhesion between metal members and resins, sealing of electronic components and the like.

Examples of applications in automotive fields include adhesion of exterior materials formed of metal members/resins in interior/exterior members such as pillars, malls, door trims, spoilers and roofs, and adhesion of base materials with genuine leathers, fabrics, instrument panel foamed sheets, and decorative sheets.

Examples of applications in other industrial fields include adhesion between films of multilayer films such as industrial packaging materials and barrier films.

Further, examples include adhesion of logistics materials, housing and building materials, everyday goods, and sporting goods.

Among these, packaging materials for lithium ion batteries are preferable as the application of the thermally fusible member of the present invention since the thermally fusible member has high room-temperature peel strength and high high-temperature peel strength and are excellent in adhesiveness, and also have high electrolyte resistance.

### EXAMPLES

Hereinafter, the present invention will be described in more specifically with reference to examples and comparative examples.

### 1. Production Example

### 1) Production Example 1 [Production of Component (A)]

100 parts by weight of a propylene-1-butene copolymer (79 mol % of propylene component, 21 mol % of 1-butene component, weight average molecular weight of 180,000, and Tm=85° C.), 2.8 parts by weight of maleic anhydride, 2 parts by weight of lauryl methacrylate, and 0.8 parts by weight of 2,5-dimethyl-2,5-di(t-butylperoxy)hexane were poured into a twin screw extruder (LD=42 and ϕ=58 mm). The reaction was carried out at a residence time of 10 minutes and a barrel temperature of 180° C. (in 1st to 7th barrels), and degassing was performed in the 7th barrel to remove the remaining unreacted maleic anhydride and lauryl methacrylate to obtain a reaction product (hereinafter referred to as “component A1”).

### 2) Production Example 2 [Production of Component (A)]

In a four-neck flask equipped with a stirrer, a condenser, and a dripping funnel, 100 parts by weight of a propylene-ethylene copolymer (97 mol % of propylene component and 3 mol % of ethylene component, weight average molecular weight of 250,000, and Tm=125° C.) was heated and dissolved in 400 parts by weight of toluene, then 1 part by weight of dicumyl peroxide was added dropwise while maintaining the temperature in the system at 110° C. and stirring, and then a degradation treatment was performed for 1 hour. Next, 1.5 parts by weight of aconitic anhydride, 3 parts by weight of octyl acrylate, 0.5 parts by weight of benzoyl peroxide were each added dropwise to the mixture over 3 hours, and the resultant mixture was allowed to react further for 1 hour. After the reaction, the reaction product was cooled to room temperature, and then the crude reaction product was poured into a large excess of acetone, and unreacted aconitic anhydride and octyl acrylate were removed to obtain a reaction product (hereinafter referred to as “component A2”).

### 3) Production Example 3 [Production of Component (A)]

100 parts by weight of a propylene-ethylene-1-butene copolymer (68 mol % of propylene component, 8 mol % of ethylene component, and 24 mol % of 1-butene component, weight average molecular weight of 50,000, and Tm=70° C.), 8 parts by weight of itaconic anhydride, 5 parts by weight of tridecyl acrylate, 2 parts by weight of lauroyl peroxide were poured into a twin screw extruder similar to that in Production Example 1. The reaction was carried out at a residence time of 10 minutes and a barrel temperature of 170° C. (in 1st to 7th barrels), and degassing was performed in the 7th barrel to remove the remaining unreacted itaconic anhydride and tridecyl acrylate to obtain a reaction product (hereinafter referred to as “component A3”).

### 4) Production Example 4 [Production of Component (B)]

In a 500 mL four-neck flask equipped with a stirrer, a thermometer, a nitrogen gas introduction tube, and a Dimroth condenser, 570 g of hydrogenated diphenylmethane diisocyanate (hereinafter abbreviated as hydrogenated MDI) and 17 g of isobutanol were prepared, heated to 85° C., and kept for 3 hours, and then 0.12 g of trimethyl-N-2-hydroxypropylammonium 2-ethylhexanoate was added as a catalyst. After continuing the reaction for 3 hours while adjusting the reaction temperature to 85±5° C., 0.1 g of benzoyl chloride was added to deactivate the catalyst and the reaction was terminated. The obtained reaction solution was treated in a thin film distillation apparatus (vacuum degree 0.5 mmHg, temperature 180° C.) to remove unreacted hydrogenated MDI, and 150 g (conversion rate 25%) of pale yellow transparent polyisocyanate having no fluidity at room temperature was obtained. A solution (hereinafter referred to as “component B1”) obtained by diluting this polyisocyanate with ethyl acetate to a solid content of 75%, had an isocyanate group content of 10%.

### 2. Method of Evaluating Reaction Product

The weight-average molecular weight, the melting point, the graft amount of the acidic group-containing monomer and/or acid anhydride group-containing monomer, and the graft amount of the (meth)acrylic acid long-chain alkyl ester of the reaction products A1 to A3 obtained in Production Examples 1 to 3 were measured according to the methods described later.

The results are shown in Table 1.

(1) Weight average molecular weight

Using 1,2,4-trichlorobenzene as an eluent, measurement was performed at a column temperature of 140° C. by means of a high-temperature GPC apparatus.

(2) Melting Point

In accordance with the provisions of JIS K 7121 (established in 1987), measurement was performed at a temperature increase rate of 10° C./min using a differential scanning calorimeter, and the temperature when crystallization occurred was taken as the melting point (hereinafter referred to as “Tm”).

(3) Graft Amount of Acid Anhydride Group-Containing Monomer

The graft amount of the acid anhydride group-containing monomer is defined by the following formula from the acid value obtained by the measurement described later.

Graft amount (% by weight)=acid value×(M+1.008)×100/(1000×56.1×V)

M=molecular weight of acid anhydride group-containing monomer

V=valence of acidic groups when the acid anhydride group-containing monomer was hydrolyzed

The graft amounts of the acid anhydride group-containing monomers of the reaction products A1 to A3 were calculated according to the following formulae.

Graft amount of A1(% by weight)=acid value×99.1×100/(1000×56.1×2)

Graft amount of A2(% by weight)=acid value×157.1×100/(1000×56.1×3)

Graft amount of A3(% by weight)=acid value×113.1×100/(1000×56.1×2)

—Method for Measuring Acid Value—

The acid value indicates the number of milligrams of potassium hydroxide required to neutralize the acid contained in 1 g of the sample, and was measured in accordance with JIS K 0070:1992.

Specifically, a sample solution is obtained by accurately weighing 0.2 g of a sample to be measured in an Erlenmeyer flask with a stopper, adding 20 ml of tetrahydrofuran, and dissolving while heating. Subsequently, several drops of a 1 w/v % phenolphthalein ethanol solution were added, as an indicator, to this sample solution, titration was carried out using 0.1 mol/L potassium hydroxide ethanol solution as a titrant until a rose-pink color lasting for 10 seconds was exhibited, and the acid value was calculated according to the following formula.

Acid value (mgKOH/g)=(T×F×56.11×0.1)/W

Here, in the above calculation formula, T represents the titration amount (mL), F represents a factor of the titrant, and W represents an amount (g) of the sampling amount.

(4) Graft Amount of (Meth)Acrylic Acid Long-Chain Alkyl Ester

First, the (meth)acrylic acid long-chain alkyl esters (concentration (% by weight): C₁, C₂ and C₃), which are raw materials of the above-mentioned reaction products A1 to A3, were mixed with the polyolefins, which are raw materials of the above-mentioned reaction products A1 to A3, using a twin-screw extruder similar to that in Production Example 1, and three types of films (thickness: 100 μm) were obtained, using a hot press, in which the concentrations of the (meth)acrylic acid long-chain alkyl esters were different from each other.

Infrared absorption spectra of the above-mentioned three types of films were measured by Fourier transform infrared spectroscopy, and absorbance ratios Y₁, Y₂ and Y3 were determined according to the following formulae, and calibration curves for the concentrations C₁, C₂ and C₃ were created.

Absorbance ratio Y=(absorbance originating in stretching vibration of ester carbonyl(1730±10 cm⁻¹))/(absorbance originating in C—H deformation vibration of CH₃ (1380±10 cm⁻¹))

Y₁: Y at a concentration of C₁

Y₂: Y at a concentration of C₂

Y₃: Y at a concentration of C₃

Next, the infrared spectra of the above-mentioned reaction products A1 to A3 were measured, and the absorbance ratios Y_{A1} (Y of the reaction product A1), Y_{A2} (Y of the reaction product A2) and Y_{A3} (Y of the reaction product A3) were determined, and graft amounts of the (meth)acrylic acid long-chain alkyl esters were calculated according to the following formulae based on the above calibration curves.

Graft amount of A1(% by weight)=(Y_{A1}−b)/a

Graft amount of A2(% by weight)=(Y_{A2}−b)/a

Graft amount of A3(% by weight)=(Y_{A3}−b)/a

a=(3f−d×e)/(3c−d²)

b=(c×e−f−d)/(3c−d²)

c=C₁²+C₂²+C₃²

d=C₁+C₂+C₃

e=Y₁+Y₂+Y₃

f=C₁Y₁+C₂Y₂+C₃Y₃

TABLE 1

| | | | | Graft amount of acid anhydride | Graft amount of (meth)acrylate |
|---|---|---|---|---|---|
| | | Weight-average | Melting point | group-containing monomer | long-chain alkyl ester |
| | | molecular weight | (° C.) | (% by weight) | (% by weight) |
| Production | A1 | 150,000 | 85 | 2.4 | 1.6 |
| Example 1 | | | | | |
| Production | A2 | 82,000 | 80 | 1.2 | 2.8 |
| Example 2 | | | | | |
| Production | A3 | 36,000 | 60 | 7.5 | 4.6 |
| Example 3 | | | | | |

(5) Ring-Opening Ratio of Anhydrous Ring of Acid Anhydride Group

The polyolefin that has an acid anhydride group and that is used as a raw material for the adhesive composition was molded into a film having a thickness of from 50 to 100 μm using a hot press. A treatment was performed such that the film was heated in an atmosphere of 120° C. for 20 hours to ring-close, by a dehydration reaction, the acid anhydride group that had been ring-opened by hydrolysis. Within 1 minute after taking out the film, the infrared absorption spectrum of the film was measured by Fourier transform infrared spectroscopy, and the absorbance ratio Y0 was determined in accordance with the following formula.

Absorbance ratio Y₀=(absorbance originating in carbonyl stretching vibration of anhydrous ring(1785±10 cm⁻¹))/(absorbance originating in C—H deformation vibration of CH₃(1380±10 cm⁻¹))

Next, a solution of the adhesive composition used for evaluation was thinly applied onto a release PET, and air-dried, after which a film having a thickness of from 50 to 100 μm was obtained. The infrared absorption spectrum of this film was measured, and the absorbance ratio Y was determined. The ring-opening ratio of the anhydrous ring of the acid anhydride group was calculated in accordance with the following formula.

Ring-opening ratio (%) of anhydrous ring=(1−Y/Y₀)×100

### 3. Examples 1 to 25, Comparative Examples 1 to 3

1) Preparation of Adhesive Compositions

The component (A) and each of the organic solvents shown in the following Table 2 were prepared in a flask having an internal volume of 300 mL and equipped with a condenser and a stirrer, and stirred at 60° C. for 30 minutes to dissolve the component (A), after which a predetermined amount of water, ethanol, or glycol ether was added, and further stirred at 60° C. for 8 hours. After the solution was cooled to room temperature, a curing catalyst was added to the solution and sufficiently mixed to obtain a liquid resin composition. Next, the component (B) and the component (C) shown in Table 2, which are isocyanate compounds, were formulated and mixed with the resin composition at the ratio shown in Table 2 to obtain the adhesive composition.

In preparing the test pieces described later, the adhesive composition was used within 1 hour after the isocyanate compounds were formulated.

The evaluations described later were carried out using the obtained adhesive compositions shown in Tables 2 and 3. The results are shown in Tables 2 and 3.

The numbers in Tables 2 and 3 mean parts by weight, and the abbreviations in Tables 2 and 3 mean the following.

[Curing Catalyst]
DBU: 1,8-diazabicyclo[5.4.0]undec-7-ene, manufactured by San-Apro Ltd.
DBTL: dibutyltin dilaurate, manufactured by ADEKA Corporation

[Component (B)]
D-127N: isocyanurate of 1,3-bis(isocyanatomethyl)cyclohexane, manufactured by Mitsui Chemicals, Inc., trade name: “Takenate D-127N”
B1: isocyanurate of a mixture of 4,4′-methylenebis(cyclohexylisocyanate) and isomers
HMDI: mixture of 4,4′-methylenebis(cyclohexylisocyanate) and isomers, manufactured by Wanhua Chemical Group Co., Ltd., trade name: “HMDI”

[Component (C)]
TPA100: isocyanurate of hexamethylene diisocyanate, manufactured by Asahi Kasei Corporation, trade name: “Duranate TPA-100”
N3200: biuret of hexamethylene diisocyanate, manufactured by Sumika Covestro Urethane Co., Ltd., trade name: “Desmodur N3200”
XP2580: allophanate of hexamethylene diisocyanate, manufactured by Sumika Covestro Urethane Co., Ltd., trade name: “Desmodur XP2580”

[Other Isocyanates]
L75: adduct of tolylene diisocyanate, manufactured by Sumika Covestro Urethane Co., Ltd., trade name: “Desmodur L75”
44V20: isomer mixture of diphenylmethane diisocyanate, manufactured by Sumika Covestro Urethane Co., Ltd., trade name “Sumidur 44V20”

2) Production of Test Piece

The adhesive composition was applied to an aluminum foil (size: 100 mm×200 mm, thickness: 40 m, and surface treatment: chemical conversion treatment) with a bar coater, then dried at 80° C. for 60 seconds to remove the organic solvent contained in the adhesive composition, and thereby an adhesive layer having a film thickness of 4 μm was formed.

Next, an unstretched polypropylene film (thickness 80 μm, hereinafter referred to as “CPP”), as a thermally fusible resin film, was affixed to the surface of the adhesive layer, and lamination was performed at a pressure of 0.3 MPa and a rate of 1 m/min using a thermal laminator in which the surface temperature of the roll was set to 80° C.

Thereafter, the thermally fusible member was housed for 3 days in a hot air circulation oven with its temperature adjusted to 40° C., and thus obtained test piece was used for evaluation.

3) Evaluation of Test Piece

The test piece obtained in 2) above was used for the evaluation described later.

(1) Adhesiveness

[Room-Temperature Peel Strength]

The above-mentioned test piece was cut into a width of 15 mm, and the room-temperature peel strength (at a measurement temperature of 25° C.) between the aluminum foil and the CPP was measured by a T peel test (at a tensile speed of 100 mm/min). The results are shown in Table 2.

[High-Temperature Peel Strength]

The above-mentioned test piece was cut into a width of 15 mm, and the high-temperature peel strength (at measurement temperatures of 80° C. and 120° C.) between the aluminum foil and the CPP was measured by a T peel test (at a tensile speed of 100 mm/min). The results are shown in Table 2.

(2) Electrolyte Resistance

As an electrolytic solution, one was used in which ethylene carbonate, diethyl carbonate, and dimethyl carbonate were mixed at a ratio of 1:1:1 (weight ratio), and lithium hexafluorophosphate was added thereto at a concentration of 1 mol/L.

After the above-mentioned test piece was immersed in the electrolytic solution at 80° C. for 8 days, the room-temperature peel strength (at a measurement temperature of 25° C.) between the aluminum foil and the CPP was measured by a T peel test (at a tensile speed of 100 mm/min). The results are shown in Table 2.

(3) Working Life

The prepared adhesive composition was placed in a glass bottle, sealed, and left to stand under an environment of 25° C. The adhesive composition was observed after 5 hours and was rated as “A” if coating was possible. If the adhesive composition had thickened, it was rated as “F”.

TABLE 2

| | | | Example | | | | | | | | |
|---|---|---|---|---|---|---|---|---|---|---|---|
| | Component | | 1 | 2 | 3 | 4 | 5 | 6 | 7 | 8 | 9 |
| Component | A1 | (g) | 15 | 15 | 15 | 15 | 15 | 15 | | | |
| (A) | A2 | (g) | | | | | | | 15 | 15 | 15 |
| | A3 | (g) | | | | | | | | | |
| Organic | Methyl | (g) | 68 | 68 | 68 | 68 | 68 | 68 | 68 | 68 | 68 |
| solvent | cyclohexane | | | | | | | | | | |
| | Methyl ethyl | (g) | 17 | 17 | 17 | 17 | 17 | 17 | 17 | 17 | 17 |
| | ketone | | | | | | | | | | |
| Water | | (mg) | 3.0 | 30 | 120 | 400 | 120 | 120 | 0.94 | 9.4 | 38 |
| Ethanol | | (mg) | | | | | | | | | |
| Propylene glycol | | (mg) | | | | | | | | | |
| monomethyl ether | | | | | | | | | | | |
| Heating | | | Y | Y | Y | Y | Y | Y | Y | Y | Y |
| (ring-opening of anhydrous ring) | | | | | | | | | | | |
| Curing | DBU | (g) | 0.08 | 0.08 | 0.08 | 0.08 | 0.08 | | 0.08 | 0.08 | 0.08 |
| catalyst | DBTL | (mg) | | | | | | 1.5 | | | |
| Component | D-127N | (g) | 3.3 | 3.3 | 3.3 | 3.3 | 6.6 | 3.3 | | | |
| (B) | B1 | (g) | | | | | | | 3.0 | 3.0 | 3.0 |
| | HMDI | (g) | | | | | | | | | |
| Component | TPA100 | (g) | 2.0 | 2.0 | 2.0 | 2.0 | | 2.0 | | | |
| (C) | N3200 | (g) | | | | | | | 0.6 | 0.6 | 0.6 |
| | XP2580 | (g) | | | | | | | | | |
| Other | L75 | (g) | | | | | | | | | |
| isocyanate | 44V20 | (g) | | | | | | | | | |
| | NCO/COOH | | 3.0 | 3.0 | 3.0 | 3.0 | 3.0 | 3.0 | 3.0 | 3.0 | 3.0 |
| Ring-opening ratio of | | % | 5 | 20 | 40 | 60 | 40 | 40 | 5 | 20 | 40 |
| anhydrous ring | | | | | | | | | | | |
| Adhesiveness | T peel | 25° C. | 24 | 24 | 25 | 25 | 22 | 25 | 24 | 24 | 25 |
| | adhesive | 80° C. | 11 | 11 | 12 | 13 | 13 | 12 | 10 | 10 | 11 |
| | strength | 120° C. | 7 | 8 | 8 | 8 | 8 | 8 | 6 | 6 | 7 |
| | (N/15 mm) | | | | | | | | | | |
| Electrolyte | Peel strength | After | 12 | 12 | 12 | 13 | 11 | 12 | 11 | 12 | 12 |
| resistance | after | 8 days | | | | | | | | | |
| | immersion | | | | | | | | | | |

| | | | | | | | | | |
|---|---|---|---|---|---|---|---|---|---|
| Working life after mixing | A | A | A | A | A | A | A | A | A |
| with curing agent | | | | | | | | | |

| | | | Example | | | | | | | | |
|---|---|---|---|---|---|---|---|---|---|---|---|
| | Component | | 10 | 11 | 12 | 13 | 14 | 15 | 16 | 17 | 18 |
| Component | A1 | (g) | | | | | | 15 | 15 | 15 | 15 |
| (A) | A2 | (g) | 15 | | | | | | | | |
| | A3 | (g) | | 15 | 15 | 15 | 15 | | | | |
| Organic | Methyl | (g) | 68 | 68 | 68 | 68 | 68 | 68 | 68 | 68 | 68 |
| solvent | cyclohexane | | | | | | | | | | |
| | Methyl ethyl | (g) | 17 | 17 | 17 | 17 | 17 | 17 | 17 | 17 | 17 |
| | ketone | | | | | | | | | | |
| Water | | (mg) | 126 | 8.2 | 82 | 328 | 1094 | 120 | 120 | | |
| Ethanol | | (mg) | | | | | | | | 68 | |
| Propylene glycol | | (mg) | | | | | | | | | 130 |
| monomethyl ether | | | | | | | | | | | |
| Heating | | | Y | Y | Y | Y | Y | Y | Y | Y | Y |
| (ring-opening of anhydrous ring) | | | | | | | | | | | |
| Curing | DBU | (g) | 0.08 | 0.08 | 0.08 | 0.08 | 0.08 | 0.08 | 0.08 | 0.08 | 0.08 |
| catalyst | DBTL | (mg) | | | | | | | | | |
| Component | D-127N | (g) | | | | | | | | 3.3 | 3.3 |
| (B) | B1 | (g) | 3.0 | | | | | | | | |
| | HMDI | (g) | | 6.0 | 6.0 | 6.0 | 6.0 | | | | |
| Component | TPA100 | (g) | | | | | | 2.0 | 2.0 | 2.0 | 2.0 |
| (C) | N3200 | (g) | 0.6 | | | | | | | | |
| | XP2580 | (g) | | 3.0 | 3.0 | 3.0 | 3.0 | | | | |
| Other | L75 | (g) | | | | | | 4.5 | | | |
| isocyanate | 44V20 | (g) | | | | | | | 1.9 | | |
| | NCO/COOH | | 3.0 | 3.0 | 3.0 | 3.0 | 3.0 | 3.0 | 3.0 | 3.0 | 3.0 |
| Ring-opening ratio of | | % | 60 | 5 | 20 | 40 | 60 | 40 | 40 | 40 | 40 |
| anhydrous ring | | | | | | | | | | | |
| Adhesiveness | T peel | 25° C. | 25 | 24 | 24 | 25 | 25 | 22 | 22 | 24 | 24 |
| | adhesive | 80° C. | 12 | 10 | 10 | 11 | 11 | 11 | 11 | 11 | 11 |
| | strength | 120° C. | 7 | 6 | 6 | 7 | 7 | 7 | 7 | 7 | 7 |
| | (N/15 mm) | | | | | | | | | | |
| Electrolyte | Peel strength | After | 13 | 11 | 12 | 12 | 12 | 11 | 11 | 12 | 12 |
| resistance | after | 8 days | | | | | | | | | |
| | immersion | | | | | | | | | | |

| | | | | | | | | | |
|---|---|---|---|---|---|---|---|---|---|
| Working life after mixing | A | A | A | A | A | A | A | A | A |
| with curing agent | | | | | | | | | |

TABLE 3

| | | | Example | | | | |
|---|---|---|---|---|---|---|---|
| | Component | | 19 | 20 | 21 | 22 | 23 |
| Component | A1 | (g) | 15 | 15 | 15 | | |
| (A) | A2 | (g) | | | | 15 | 15 |
| | A3 | (g) | | | | | |
| Organic | Methyl | (g) | 68 | 68 | 68 | 68 | 68 |
| solvent | cyclohexane | | | | | | |
| | Methyl ethyl | (g) | 17 | 17 | 17 | 17 | 17 |
| | ketone | | | | | | |
| Water | | (mg) | 0 | 1.00 | 120 | 0 | 0.47 |
| Ethanol | | (mg) | | | | | |
| Propylene glycol | | (mg) | | | | | |
| monomethyl ether | | | | | | | |
| Heating | | | Y | Y | N | Y | Y |
| (ring-opening of anhydrous ring) | | | | | | | |
| Curing | DBU | (g) | 0.08 | 0.08 | 0.08 | 0.08 | 0.08 |
| catalyst | DBTL | (mg) | | | | | |
| Component | D-127N | (g) | 3.3 | 3.3 | 3.3 | | |
| (B) | B1 | (g) | | | | 3.0 | 3.0 |
| | HMDI | (g) | | | | | |
| Component | TPA100 | (g) | 2.0 | 2.0 | 2.0 | | |
| (C) | N3200 | (g) | | | | 0.6 | 0.6 |
| | XP2580 | (g) | | | | | |
| Other | L75 | (g) | | | | | |
| isocyanate | 44V20 | (g) | | | | | |
| | NCO/COOH | | 3.0 | 3.0 | 3.0 | 3.0 | 3.0 |
| Ring-opening ratio of | | % | 0 | 2 | 2 | 0 | 2 |
| anhydrous ring | | | | | | | |
| Adhesiveness | T peel | 25° C. | 24 | 23 | 24 | 24 | 24 |
| | adhesive | 80° C. | 9 | 9 | 9 | 8 | 8 |
| | strength | 120° C. | 4 | 4 | 4 | 3 | 3 |
| | (N/15 mm) | | | | | | |
| Electrolyte | Peel strength | After 8 | 10 | 10 | 10 | 10 | 10 |
| resistance | after | days | | | | | |
| | immersion | | | | | | |

| | | | | | |
|---|---|---|---|---|---|
| Working life after mixing | A | A | A | A | A |
| with curing agent | | | | | |

| | | | Example | | Comparative Example | | |
|---|---|---|---|---|---|---|---|
| | Component | | 24 | 25 | 1 | 2 | 3 |
| Component | A1 | (g) | | | 15 | | |
| (A) | A2 | (g) | | | | 15 | |
| | A3 | (g) | 15 | 15 | | | 15 |
| Organic | Methyl | (g) | 68 | 68 | 68 | 68 | 68 |
| solvent | cyclohexane | | | | | | |
| | Methyl ethyl | (g) | 17 | 17 | 17 | 17 | 17 |
| | ketone | | | | | | |
| Water | | (mg) | 0 | 4.1 | 1200 | 377 | 3281 |
| Ethanol | | (mg) | | | | | |
| Propylene glycol | | (mg) | | | | | |
| monomethyl ether | | | | | | | |
| Heating | | | Y | Y | Y | Y | Y |
| (ring-opening of anhydrous ring) | | | | | | | |
| Curing | DBU | (g) | 0.08 | 0.08 | 0.08 | 0.08 | 0.08 |
| catalyst | DBTL | (mg) | | | | | |
| Component | D-127N | (g) | | | 3.3 | | |
| (B) | B1 | (g) | | | | 3.0 | |
| | HMDI | (g) | 6.0 | 6.0 | | | 6.0 |
| Component | TPA100 | (g) | | | 2.0 | | |
| (C) | N3200 | (g) | | | | 0.6 | |
| | XP2580 | (g) | 3.0 | 3.0 | | | 3.0 |
| Other | L75 | (g) | | | | | |
| isocyanate | 44V20 | (g) | | | | | |
| | NCO/COOH | | 3.0 | 3.0 | 3.0 | 3.0 | 3.0 |
| Ring-opening ratio of | | % | 0 | 2 | 70 | 70 | 70 |
| anhydrous ring | | | | | | | |
| Adhesiveness | T peel | 25° C. | 24 | 24 | 25 | 25 | 25 |
| | adhesive | 80° C. | 7 | 7 | 13 | 12 | 11 |
| | strength | 120° C. | 3 | 3 | 8 | 7 | 7 |
| | (N/15 mm) | | | | | | |
| Electrolyte | Peel strength | After 8 | 10 | 10 | 13 | 13 | 12 |
| resistance | after | days | | | | | |
| | immersion | | | | | | |

| | | | | | |
|---|---|---|---|---|---|
| Working life after mixing | A | A | F | F | F |
| with curing agent | | | | | |

(4) Evaluation Results

As is clear from the results of Examples 1 to 18, even if the adhesive composition of the present invention was cured at 40° C. for 3 days, the adhesive composition had a high room-temperature peel strength of 10 N/15 mm or more, as well as had an 80° C. peel strength of 7 N/15 mm or more and a 120° C. peel strength of 6 N/15 mm or more, was thus excellent in adhesiveness and was also excellent in electrolyte resistance.

In contrast, since the adhesive composition of Comparative Examples 1 to 7 had a ring-opening ratio of 5% or less, the hardening reaction was not sufficient after curing at 40° C. for 3 days, and the 80° C. and 120° C. peel strengths were low. Since the adhesive composition of Comparative Examples 8 to 10 had a ring-opening ratio of 60% or more, the 80° C. and 120° C. peel strengths were sufficient; however, since the ring-opening ratio was too high, the working life after formulating the curing agent was less than 5 hours.

As for Examples 2-1 to 2-6 and Comparative Example 2-1, the respective physical property values were measured as follows.

<Method of Analyzing Ring-Opening Ratio of Acid Anhydride Ring>

IR1: Method of dehydration ring closure of dibasic acid moiety

When the polymer graft-modified with maleic anhydride was vacuum-dried at 150° C. for 2 hours, the dibasic acid moiety formed by ring-opening by moisture absorption or the like underwent dehydration ring closure to an extent that the moiety could not be distinguished in the IR spectrum. This was cooled to room temperature in the dry state, and was considered as the acid anhydride ring being closed 100%.

IR2: Method of Ring-Opening of Acid Anhydride Ring by Moisture Absorption

The polymer graft-modified with maleic anhydride was pulverized and placed in a glass vial with the lid removed. This vial that contains a sample without a lid and a 100 ml beaker that contains 100 ml of water were placed on a glass plate, covered with a glass bell jar from above, and the opening of the bell jar was closed with a rubber stopper. This was left in a thermostatic chamber at 24° C. for a predetermined time to promote ring-opening of the acid anhydride ring in the acid-modified polymer.

IR3: Preparation of Sample for Infrared Absorption Spectrum Measurement

A small amount of the acid-modified polymer obtained in IR1 and IR2 above was taken out, sandwiched by two fluororesin sheets each having a thickness of 1 mm, and pressed by a hot press at 100° C. to form a film. This film-shaped sample was placed in a moisture-proof bag, sealed, and left at room temperature for 1 day or more to promote crystallization. According to research by the present inventors, if the infrared absorption spectrum is measured without promoting the crystallization, the acid value tended to be slightly overestimated, and the results of acid value measurement was consistent after being left for 1 day or more. Therefore, the sample was left at room temperature.

IR4: Measurement of Infrared Absorption Spectrum

The above-described film sample was measured by a transmission method using an FT-IR measuring device (Nicolet iS50 manufactured by Thermo Fisher Scientific Co., Ltd.).

IR5: Calculation of Ring-Opening Ratio of Acid Anhydride Ring

An absorbance at a wave number of 1786 cm⁻¹ was calibrated based on an absorption peak at a wave number of which absorption does not increase or decrease depending on the ring-opening state of the acid anhydride group, and the ring-opening ratio was estimated by comparison with the height of the calibrated absorption peak derived from the acid anhydride.

In this calculation, since an absorption peak of carboxyl group in the vicinity of 1710 cm⁻¹ was no longer observed in the infrared absorption spectrum of the product that had been vacuum-dried at 150° C. for 2 hours, the ring-opening ratio of the acid anhydride ring in this state was defined as 0%. In addition, a reference absorption peak that is not affected by acid anhydride groups or water was calculated as a peak at a wave number of 1164 cm⁻¹.

<Calculation Formula>

In the infrared absorption spectrum of a sample that had been vacuum dried at 150° C. for 2 hours, the absorbance of an absorbance peak at 1164 cm⁻¹ is designated as 1, which is used for calibrating the absorbance at a wave number of 1786 cm⁻¹ peak, the calibrated absorbance being designated as X. That is, X is calculated by the following formula.

Measured absorbance at 1786 cm⁻¹ of dried polymer/measured absorbance at 1164 cm⁻¹ of dried polymer=X

In the infrared absorption spectrum of the acid-modified polymer in which the acid anhydride ring is partially opened by moisture absorption, the calibrated peak height at a wave number of 1786 cm⁻¹ is designated as Y. That is, Y is calculated by the following formula.

Measured absorbance at 1786 cm⁻¹ of moistened polymer/measured absorbance at 1164 cm⁻¹ of moistened polymer=Y

From the calibrated absorbances X and Y, the ring-opening ratio is calculated as follows.

Ring-opening ratio [%]=(X−Y)/X×100

<Measurement of Acid Value>

AC1: 35 g of un-acid-modified polymer pellets and dodecylsuccinic anhydride (additive-free, 1 g, 2 g, 4 g) were respectively weighed, were placed in a Labo Plastomill (manufactured by Toyo Seiki Seisaku-sho Ltd.) that was heated to 170° C., and stirred while heating to prepare four samples each having a different dodecylsuccinic anhydride content.

AC2: A small amount of the sample was cut out, and a film was prepared using a hot press heated to 100° C. in the same manner as in the method described in IR3.

AC3: From the transmission IR spectra of the four samples, a calibration curve of a ratio of the absorbance at 1786 cm⁻¹ relative to the absorption at 1164 cm⁻¹ was created.

AC4: A dehydration ring closure of the acid-modified polymer was carried out by the method indicated in IR1, and the infrared absorption spectrum was measured in the same manner.

AC5: From the spectrum measured in AC4, a ratio of the absorbance at 1786 cm⁻¹ relative to the absorption at 1164 cm⁻¹ was determined and compared with the calibration curve created in AC3, and the acid value was measured. In this case, the acid value of the sample that had undergone the dehydration ring closure process was defined as a ring-opening ratio of 0%.

<Melt Flow Rate Measurement Method>

Measurement was performed using a Melt Indexer G-02 manufactured by Toyo Seiki Seisaku-sho Ltd. under automatic measurement mode at a furnace temperature of 190° C. and a load of 2.17 kg.

<Ring-Opening Method by Moisture Absorption>

The polymer graft-modified with maleic anhydride was pulverized, and was left to stand for a predetermined time using the method described in IR2, to promote ring-opening of the acid anhydride ring in the acid-modified polymer.

<Working Life Test Method>

The prepared adhesive composition was placed in a glass bottle, sealed, and left to stand in an environment of 25° C. The composition was observed after 5 hours and was rated as “A” if coating was possible. If it had thickened, it was rated as “F”.

<Liquid Stability Test Method>

When preparing the adhesive composition, after mixing the isocyanate compound, the mixture was allowed to stand at 25° C. in air, and the time until a coating operation could not be performed due to thickening or gelation was measured separately. The adhesive composition was evaluated at 1, 2, 5, 12, 24 and 48 hours after the mixing, and those samples that could be applied as a coating were rated as “A” and those that could not be applied as a coating were rated as “F”.

<Peeling Test Method>

A sample obtained by laminating an aluminum foil and an unstretched polypropylene film was produced, and then cut out into a width of 15 mm to obtain a test piece. The peel strength between the aluminum foil and the polypropylene film was measured by a T peel test at a crosshead speed of 100 mm/min. The measurement temperature was set at three levels: 25° C., 80° C., and 120° C.

<Method of Measuring Electrolyte Resistance>

Ethylene carbonate is most commonly used as the electrolyte in a lithium ion battery; however, it is usually used with another solvent that is added in order to ensure operation in cold regions and the like. Of these additives, since propyl propionate, which has compatibility parameters close to those of polyolefins used in adhesives or sealant layers, tends to easily reduce the adhesive strength, the peel strength was measured after immersing a test piece for a peel test that was cut into a width of 15 mm in propyl propionate heated to 85° C. for 24 hours. The measurement was performed at a crosshead speed of 100 mm/min and a measurement temperature of 25° C.

<Dynamic Viscosity Measurement Method>

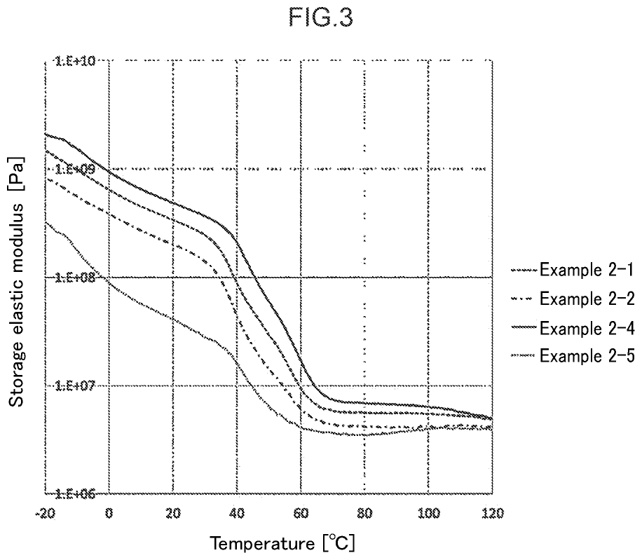

The dynamic viscoelasticity of adhesive compositions obtained from acid-modified polymers having different ring-opening ratios of acid anhydride rings was measured by the following method. The adhesive composition was poured into a polyethylene mold and left to air dry, and was then cured at 40° C. for 5 days to prepare a sheet having a thickness of about 0.5 mm. The sheet was cut into a strip having a width of about 5 mm and used for measurement of the dynamic viscoelasticity of the adhesive cured product. Using a DMS6100 manufactured by Hitachi High-Tech Science Corporation, the measurement was performed from −20° C. to 120° C. at a temperature increase rate of 20° C./min and a frequency of 1 Hz. Measurements were made in Examples 2-1, 2-2, 2-4 and 2-5 described below, and the measurement results are shown in FIG. 3. Note that “1·E+08” and the like in FIG. 3 respectively represents “1×10⁸” and the like.

<Acid Modification Example 1 of Polymer>

1000 g of a copolymer of propene and 1-butene (Tafmer XM7070 manufactured by Mitsui Chemicals, Inc.), 75 g of maleic anhydride, and 63 g of peroxide (Perbutyl E manufactured by NOF Corporation) were mixed, and modified by kneading with a twin-screw kneading extruder (TEX25αIII manufactured by The Japan Steel Works, Ltd.) that was set to a maximum temperature of 190° C. This was dissolved in toluene at a concentration of 10%, added to acetone, re-precipitated, and purified. The resultant was vacuum dried at 150° C. for 2 hours, and the acid value was measured and found to be 32.0 mgKOH/g (0.57 mmol/g as a carboxyl group). The melt flow rate was 290 g/10 min (190° C./2.17 kg).

### Example 2-1

The acid-modified polymer obtained in the acid modification example 1, without the drying step, was used in the formulation of the composition. The ring-opening ratio found from the infrared absorption spectrum of this acid-modified polymer was 10.7%. 15 g of this acid-modified polymer was added and sealed in a glass bottle with 85 g of a mixed solvent of methylcyclohexane:methylethylketone=8:2 (weight ratio), left overnight, and then completely dissolved in a water bath at 70° C. The dissolved solution was cooled to room temperature and, to this, 0.048 g of dibutyltin laurate as a catalyst, and 2.3 g of an isocyanurate type of hexane diisocyanate (Duranate TPA-100 manufactured by Asahi Kasei Corporation) and 4.0 g of an isocyanurate type of hydrogenated xylylene diisocyanate (Takenate D127N manufactured by Mitsui Chemicals, Inc.) (3 times the number of isocyanate groups compared to the amount of carboxyl groups when all the acid anhydride rings were opened; amount of cross-linking agent: 29.7% by weight with respect to the total solid content) as cross-linking agents were added, and stirred quickly until uniform to prepare an adhesive composition. This adhesive composition was dispensed onto a chemical-treated aluminum foil having a thickness of 40 μm, coated using an applicator bar so as to have a thickness of about 2 μm after dried, placed in an oven at 80° C., and dried for 1 minute. An unstretched polypropylene film having a thickness of 80 μm and having been subjected to corona treatment was overlaid onto the adhesive-coated surface of the aluminum foil that had been coated with the adhesive composition and dried, and was laminated with a laminator having a roll temperature of 80° C. The laminated test piece was cured in a constant temperature bath at 40° C. for 5 days, and then cut into a strip having a width of 15 mm to obtain a test piece for a peeling test. The electrolyte resistance of this strip-shaped test piece was measured by the method described above. In addition, after mixing with the isocyanate, the time until the coating operation could not be performed due to thickening or gelation was measured separately (the liquid stability). The dynamic viscoelasticity was measured by the method described above using a part of the remaining solution. Further, the working life test was carried out using the obtained adhesive composition.

### Example 2-2

The acid-modified polymer obtained in the acid modification example 1 was pulverized and then moistened in the bell jar for 2 hours, after which the acid-modified polymer was used in the formulation. The ring-opening ratio found from the infrared absorption spectrum of this acid-modified polymer was 12.5%. Evaluation of the adhesive composition was carried out in the same manner as in Example 2-1 except that this polymer was used.

### Example 2-3

The acid-modified polymer obtained in the acid modification example 1 was pulverized and then moistened in the bell jar for 3.5 hours, after which the acid-modified polymer was used in the formulation. The ring-opening ratio found from the infrared absorption spectrum of this acid-modified polymer was 17.5%. Evaluation of the adhesive composition was carried out in the same manner as in Example 2-1 except that this polymer was used.

### Example 2-4

The acid-modified polymer obtained in the acid modification example 1 was vacuum-dried at 150° C. for 2 hours and used in the formulation. The ring-opening ratio found from the infrared absorption spectrum of this acid-modified polymer was 0.0%. Evaluation of the adhesive composition was carried out in the same manner as in Example 2-1 except that this polymer was used.

### Example 2-5

The acid-modified polymer obtained in the acid modification example 1 was pulverized and then moistened in the bell jar for 5 hours, after which the acid-modified polymer was used in the formulation. The ring-opening ratio found from the infrared absorption spectrum of this acid-modified polymer was 23.3%. Evaluation of the adhesive composition was carried out in the same manner as in Example 2-1 except that this polymer was used.

### Example 2-6

The acid-modified polymer obtained in the acid modification example 1 was pulverized and then moistened in the bell jar for 20 hours, after which the acid-modified polymer was used in the formulation. The ring-opening ratio found from the infrared absorption spectrum of this acid-modified polymer was 44.4%. Evaluation of the adhesive composition was carried out in the same manner as in Example 2-1 except that this polymer was used. When dissolving this polymer in the solvent, it was less soluble than in the other examples. In Examples 2-1 to 2-5, the entirety thereof became transparent when left overnight at room temperature after formulation, and when heated to 70° C. thereafter, it could be completely dissolved in about 30 minutes. On the other hand, in Example 2-6, clusters of powder (lumps) remained even after being left overnight. It took 1 hour or longer to completely dissolve the polymer in a water bath at 70° C., and workability was not favorable.

### Comparative Example 2-1

The acid-modified polymer obtained in the acid modification example 1 was pulverized and then moistened in the bell jar for 43 hours, after which the acid-modified polymer was used in the formulation. The ring-opening ratio found from the infrared absorption spectrum of this acid-modified polymer was 60.9%. Evaluation of the adhesive composition was carried out in the same manner as in Example 2-1 except that this polymer was used. When dissolving this polymer in the solvent, it was even less soluble than in Comparative Example 2. It took 3 hours or longer to completely dissolve the polymer in a water bath at 70° C., and workability was not favorable.

The evaluation results of Examples 2-1 to 2-6 and Comparative Example 2-1 are collectively shown in Table 4.

TABLE 4

| | Polyolefin (A) | | | | | | | | | | | | |
|---|---|---|---|---|---|---|---|---|---|---|---|---|---|
| | Moisture | Ring- | | | | | | | | | | | Electrolyte |
| | absorption | opening | Working | Liquid stability | | | | | | Peel strength (N/15 mm) | | | resistance |
| | time (h) | ratio (%) | life | 1 hr | 2 hrs | 5 hrs | 12 hrs | 24 hrs | 48 hrs | 25° C. | 80° C. | 120° C. | (N/15 mm) |
| Example | 0 | 10.7 | A | A | A | A | A | A | A | 21.4 | 7.2 | 5.9 | 12.9 |
| 2-1 | | | | | | | | | | | | | |
| Example | 2 | 12.5 | A | A | A | A | F | — | — | 21.6 | 7.2 | 6.2 | 12.5 |
| 2-2 | | | | | | | | | | | | | |
| Example | 3.5 | 17.5 | A | A | A | A | F | — | — | 21.3 | 6.5 | 5.1 | 10.3 |
| 2-3 | | | | | | | | | | | | | |
| Example | Dry | 0 | A | A | A | A | A | A | A | 21.5 | 7.6 | 6.3 | 14.6 |
| 2-4 | | | | | | | | | | | | | |
| Example | 5 | 23.3 | A | A | A | F | — | — | — | 21.7 | 4.3 | 3.4 | 9.2 |
| 2-5 | | | | | | | | | | | | | |
| Example | 20 | 44.4 | A | F | — | — | — | — | — | 21.2 | 3.8 | 2.6 | 8.5 |
| 2-6 | | | | | | | | | | | | | |
| Comparative | 43 | 60.9 | F | F | — | — | — | — | — | 21.7 | 4.1 | 2.2 | 8.2 |
| Example 2-1 | | | | | | | | | | | | | |

As shown in Table 4, the adhesive composition of Examples 2-1 to 2-6 had a longer working life than the adhesive composition of Comparative Example 2-1 even when cured using a cross-linking agent.

Further, the smaller the ring-opening ratio of the acid anhydride ring, the more favorable the liquid stability tended to be. Example 3 can be coated for up to 5 hours, and may even be used in a coating apparatus.

While there is no difference in the peel strength when the measurement temperature is in the vicinity of room temperature, the peel strength in the high-temperature range tends to increase as the ring-opening ratio decreases. Further, it can be seen that the peel strength after immersion in propyl propionate at 85° C. is also higher when the ring-opening ratio is smaller.

As a result of measuring the dynamic viscoelasticity of four samples having different ring-opening ratios of the acid anhydride rings, and drawing the storage elastic moduli in a graph, as shown in FIG. 3, the smaller the ring-opening ratio of the acid anhydride ring, the higher the temperature at which the elastic modulus begins to decrease, and the elastic modulus of the so-called rubbery plateau at a temperature higher than about 70° C. increases as the ring-opening ratio of the acid anhydride ring decreases. As such, even if the formulation of the composition is the same, the smaller the ring-opening ratio of the acid anhydride ring of the polymer, the higher the elastic modulus at any temperature, and it is thought that the magnitude of the peel strength maintains the same sequence even at temperatures other than the three points at which the peel strength was measured.

### INDUSTRIAL APPLICABILITY

The present invention relates to an adhesive composition and a thermally fusible member using the same, can be used in various industrial products in the field of electricity, the field of automobiles and other industrial fields, and belongs to these technical fields.

1. An adhesive composition, comprising:
an organic solvent;
(A) a polyolefin that has an acid anhydride group and that is soluble in the organic solvent; and
a cross-linking agent,
wherein a ring-opening ratio of an anhydrous ring of the acid anhydride group in (A) the polyolefin is from 0 to 60%.

2. The adhesive composition according to claim 1, wherein the ring-opening ratio of the anhydrous ring of the acid anhydride group in (A) the polyolefin is from 5 to 60%.

3. The adhesive composition according to claim 1, wherein the ring-opening ratio of the anhydrous ring of the acid anhydride group in (A) the polyolefin is from 0 to 20%.

4. The adhesive composition according to claim 1, wherein the cross-linking agent is an isocyanate compound.

5. The adhesive composition according to claim 4, wherein the isocyanate compound is (B) at least one of an isocyanate compound having an alicyclic structure or a derivative thereof.

6. The adhesive composition according to claim 5, wherein the isocyanate compound having an alicyclic structure is at least one selected from the group consisting of hydrogenated xylylene diisocyanate, a derivative of hydrogenated xylylene diisocyanate, 4,4′-methylenebis(cyclohexyl isocyanate), an isomer of 4,4′-methylenebis(cyclohexyl isocyanate), a derivative of 4,4′-methylenebis(cyclohexyl isocyanate), and a derivative of an isomer of 4,4′-methylenebis(cyclohexyl isocyanate).

7. The adhesive composition according to claim 1, further comprising (C) at least one of an aliphatic isocyanate compound not having an alicyclic structure, and/or a derivative thereof.

8. The adhesive composition according to claim 7, wherein the aliphatic isocyanate compound not having an alicyclic structure is a compound having a linear alkyl group with 4 to 18 carbon atoms.

9. The adhesive composition according to claim 5, wherein the derivative of the isocyanate compound having an alicyclic structure is a compound containing at least one bond selected from the group consisting of an isocyanurate bond, a biuret bond, a urethane bond and an allophanate bond.

10. The adhesive composition according to claim 8, wherein the derivative of the aliphatic isocyanate compound not having an alicyclic structure is a compound containing at least one bond selected from the group consisting of an isocyanurate bond, a biuret bond, a urethane bond and an allophanate bond.

11. The adhesive composition according to claim 1, wherein (A) the polyolefin is a polyolefin that has been graft-modified with an acid anhydride group-containing monomer or with an acidic group-containing monomer and an acid anhydride group-containing monomer, and a graft amount of the acid anhydride group-containing monomer is from 0.10 to 30% by weight.

12. The adhesive composition according to claim 1, wherein (A) the polyolefin is a polyolefin that has been graft-modified with an esterified product of an alkyl alcohol having 8 to 18 carbon atoms and (meth)acrylic acid, and a graft amount thereof is from 0.10 to 20% by weight.

13. The adhesive composition according to claim 1, wherein the (A) polyolefin has a weight average molecular weight of from 15,000 to 200,000 and a melting point of from 50 to 110° C.

14. A thermally fusible member, comprising:
an adhesive layer obtained by curing the adhesive composition according to claim 1;
a metal layer bonded to one surface side of the adhesive layer; and
a thermally fusible resin layer bonded to another surface side of the adhesive layer.

15. A packaging material for a lithium ion battery, comprising the thermally fusible member according to claim 14.
